(19) United States
(12) Patent Application Publication
(10) Pub. No.: US 2015/0235478 A1
(43) Pub. Date: Aug. 20, 2015

(54) GLOBAL POSITIONING SYSTEM BASED TOLL ROAD PRICING

(71) Applicant: International Business Machines Corporation, Armonk, NY (US)

(72) Inventors: Sebastien Blandin, Singapore (SG); Vianney Boeuf, Issy-les-Moulineaux (FR)

(73) Assignee: International Business Machines Corporation, Armonk, NY (US)

(21) Appl. No.: 14/181,495

(22) Filed: Feb. 14, 2014

(51) Int. Cl. G07B 15/06; G06Q 30/02

(52) U.S. Cl. CPC G07B 15/06; G06Q 30/0206

(57) ABSTRACT

A toll system for a set of road portions where tolls are set on a per vehicle and per journey basis. Each time a given vehicle plans to take a journey the tolls are computed for that vehicle and for that journey, and the amount of the tolls are set based, at least in part, on the characteristics of the vehicle and/or the planned journey. This can incentivize more socially desirable traffic flows.

### STATEMENT REGARDING PRIOR DISCLOSURES BY THE INVENTOR OR A JOINT INVENTOR

The following disclosure(s) are submitted under 35 U.S.C. 102(b)(1)(A): DISCLOSURE(S):

(1) Vianney Boeuf and Sébastien Blandin, “Lagrangian Road Pricing,” International Conference on Operations Research and Enterprise Systems (ICORES), Feb. 16-18, 2013, pp. 292-97, SciTePress.

(2) Vianney Boeuf and Sebastien Blandin, “Lagrangian Road Pricing,” International Conference on Operations Research and Enterprise Systems (ICORES), presented Feb. 16, 2013.

### BACKGROUND OF THE INVENTION

The present invention relates generally to the field of traffic modeling, and more particularly to congestion toll pricing.

Traffic congestion is a significant problem in many locales throughout the world, with costs that include lost hours, environmental threats, and wasted fuel consumption. The costs of traffic congestion can be measured in hundreds of dollars per capita per year in the United States. It is known that traffic conditions resulting from typical non-cooperative behavior of selfish drivers do not minimize total travel time spent on the road network. It is further known that one way of addressing traffic congestion is to charge tolls, on roads known to become congested, based on location and/or time of day. The tolls tend to reduce congestion on the toll road, and this disincentive to use the toll road is generally positively correlated with the cost of the toll.

Congestion pricing is a known technique that attempts to change vehicle allocation over a set of roads from a “natural state of traffic” (typically assumed to be a user equilibrium or “Wardrop equilibrium”) to the best possible allocation of traffic (“social optimum allocation”). A user equilibrium can be quite different than the social optimum. Toll pricing schemes aim at creating a “tolled user equilibrium” which is at, or at least close to, the social optimum traffic allocation for the road network. A basic solution consists of “internalizing externalities” by charging users with the marginal costs they occur to the network. However, more specific operator or user-driven constraints such as profit maximization, or fairness guarantees, have historically motivated the search for other pricing schemes.

### SUMMARY

According to an aspect of the present invention, there is a method, system, and/or computer program product for setting tolls. The method includes the following steps (not necessarily in the following order): (a) collecting demand information representing estimated usage of multiple roads by multiple vehicles, with each road including at least one road portion; and (b) determining multiple sets of tolls. Each set of tolls of the determined sets of tolls: (i) respectively corresponds to a specific respective vehicle of the multiple vehicles, (ii) includes tolls for each road portion of the multiple roads, and (iii) is based, at least in part, upon the estimated usage. At least the determination of a plurality of sets of tolls is performed by a machine using machine logic.

### BRIEF DESCRIPTION OF THE SEVERAL VIEWS OF THE DRAWINGS

FIG. 1 is a schematic view of a first embodiment of a toll road system according to the present invention;

FIG. 2 is a flowchart showing a process performed, at least in part, by the first embodiment system;

FIG. 3 is a schematic view of a software portion of the first embodiment system;

FIG. 4 is a nine node diagram representing road portions that is helpful in understanding some embodiments of the present invention;

FIG. 5 is a first road map diagram representing diagram representing road portions that is helpful in understanding some embodiments of the present invention;

FIG. 6 is a second road map diagram representing diagram representing road portions that is helpful in understanding some embodiments of the present invention;

FIG. 7 is a diagram representing diagram helpful in understanding some embodiments of the present invention; and

FIG. 8 is a third road map diagram representing diagram representing road portions that is helpful in understanding some embodiments of the present invention.

### DETAILED DESCRIPTION

Some embodiments of the present invention use “trajectory-based road pricing” with the objective of reducing congestion on a road network. In some embodiments of the present invention: (i) real-time GPS data is collected from a set of vehicles on a set of roads; (ii) toll pricing is set on a vehicle by vehicle basis; and (iii) toll pricing takes into account at least the following factors: (a) origin/destination, and (b) the path taken by the vehicle from its origin to its destination. Some embodiments of the present invention use a new formulation of a set of multi-commodity prices based on a price potential, and describe an efficient algorithm to construct such multi-commodity prices. Some embodiments of the present invention analyze a subset of valid prices satisfying several specific user-driven constraints. The numerical performances may be assessed on a benchmark network. Some embodiments of the present invention may include one, or more, of the following features, characteristics and/or advantages: (i) efficient and/or effective network pricing for networks of roads having tolls (sometimes herein referred to as “charges”); (ii) multi-commodity network allocations (allowing different prices for different origin—destination pairs); (iii) computation of optimal road charges when sub-sampled trajectories of vehicles are available from GPS devices; (iv) personalized spatio-temporal charges to individual vehicles; (v) variational formulation of a set of Lagrangian prices that transforms a network allocation into a user equilibrium; (vi) use of an analytical formulation that leads to a dynamic programming algorithm; (vii) a dynamic programming algorithm which is much faster than existing methods; and/or (viii) an analytical formulation that allows for the integration of additional constraints such as sensibility to positioning errors and/or fairness constraints.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

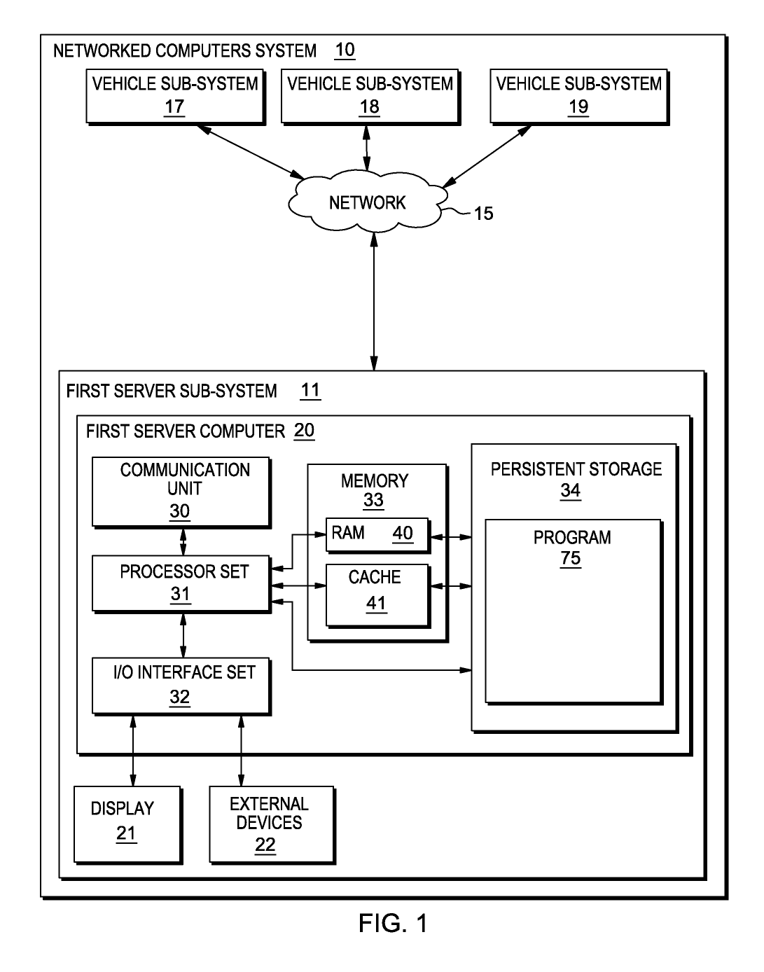

An embodiment of a possible hardware and software environment for software and/or methods according to the present invention will now be described in detail with reference to the Figures. FIG. 1 is a functional block diagram illustrating various portions of a networked computers system 10, including: first server sub-system 11; vehicle sub-systems 17, 18, 19; communication network 15; first server computer 20; communication unit 30; processor set 31; input/output (i/o) interface set 32; memory device 33; persistent storage device 34; display device 21; external device set 22; random access memory (RAM) 40; cache memory device 41; and program 75.

Sub-system 11 is, in many respects, representative of the various computer sub-system(s) in the present invention. Accordingly, several portions of sub-system 11 will now be discussed in the following paragraphs.

Sub-system 11 may be a laptop computer, tablet computer, netbook computer, personal computer (PC), a desktop computer, a personal digital assistant (PDA), a smart phone, or any programmable electronic device capable of communicating with the client sub-systems via network 15. Program 75 is a collection of machine readable instructions and/or data that is used to create, manage and control certain software functions that will be discussed in detail, below, in the Example Embodiment sub-section of this Detailed Description section.

Sub-system 11 is capable of communicating with other computer sub-systems via network 15. Network 15 can be, for example, a local area network (LAN), a wide area network (WAN) such as the Internet, or a combination of the two, and can include wired, wireless, or fiber optic connections. In general, network 15 can be any combination of connections and protocols that will support communications between server and client sub-systems.

Sub-system 11 is shown as a block diagram with many double arrows. These double arrows (no separate reference numerals) represent a communications fabric, which provides communications between various components of sub-system 11. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 33 and persistent storage 34 are computer-readable storage media. In general, memory 33 can include any suitable volatile or non-volatile computer-readable storage media. It is further noted that, now and/or in the near future: (i) external device(s) 22 may be able to supply, some or all, memory for sub-system 11; and/or (ii) devices external to sub-system 11 may be able to provide memory for sub-system 11.

Program 75 is stored in persistent storage 34 for access and/or execution by one or more of the respective computer processors 31, usually through one or more memories of memory 33. Persistent storage 34: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 34.

Program 75 may include both machine readable and performable instructions and/or substantive data (that is, the type of data stored in a database). In this particular embodiment, persistent storage 34 includes a magnetic hard disk drive. To name some possible variations, persistent storage 34 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 34 may also be removable. For example, a removable hard drive may be used for persistent storage 34. Other examples include optical and magnetic disks, thumb drives, and smart cards that are inserted into a drive for transfer onto another computer-readable storage medium that is also part of persistent storage 34.

Communications unit 30, in these examples, provides for communications with other data processing systems or devices external to sub-system 11. In these examples, communications unit 30 includes one or more network interface cards. Communications unit 30 may provide communications through the use of either or both physical and wireless communications links. Any software modules discussed herein may be downloaded to a persistent storage device (such as persistent storage device 34) through a communications unit (such as communications unit 30).

I/O interface set 32 allows for input and output of data with other devices that may be connected locally in data communication with server computer 20. For example, I/O interface set 32 provides a connection to external device set 22. External device set 22 will typically include devices such as a keyboard, keypad, a touch screen, and/or some other suitable input device. External device set 22 can also include portable computer-readable storage media such as, for example, thumb drives, portable optical or magnetic disks, and memory cards. Software and data used to practice embodiments of the present invention, for example, program 75, can be stored on such portable computer-readable storage media. In these embodiments the relevant software may (or may not) be loaded, in whole or in part, onto persistent storage device 34 via I/O interface set 32. I/O interface set 32 also connects in data communication with display device 21.

Display device 21 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. Example Embodiment

Preliminary note: The flowchart and block diagrams in the following Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

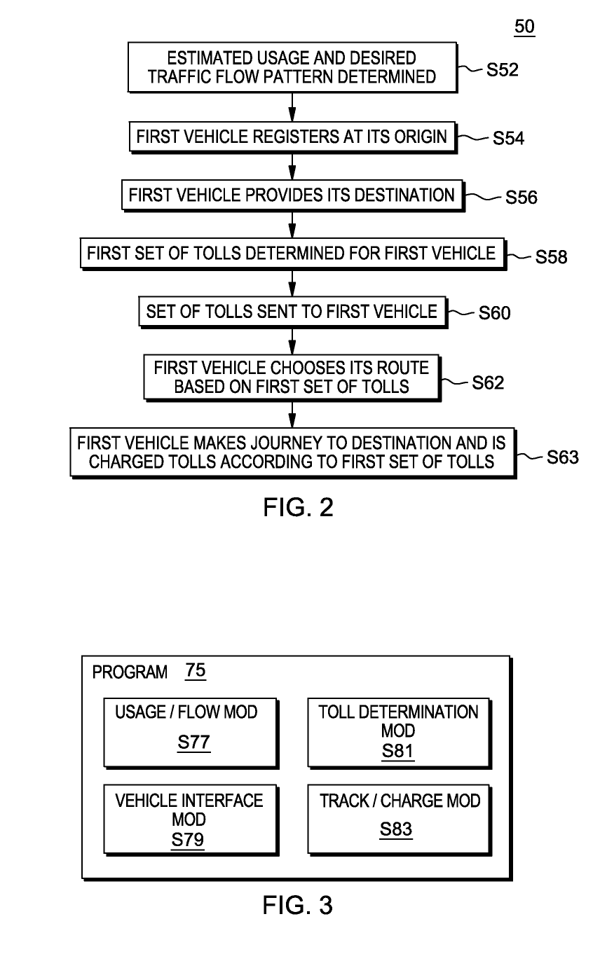

FIG. 2 shows a flow chart 50 depicting a method according to the present invention. FIG. 3 shows program 75 for performing at least some of the method steps of flow chart 50. This method and associated software will now be discussed, over the course of the following paragraphs, with extensive reference to FIG. 2 (for the method step blocks) and FIG. 3 (for the software blocks).

Processing begins at step S52 where, at a first point in time t0, usage flow module (“mod”) 77 of program 75 of first server sub-system 11 (see FIG. 1): (i) estimates usage of a set of roads by vehicles authorized to travel on the roads; (ii) determines a desired traffic flow pattern for the set of roads; and (iii) performs “behavior change value” determination(s) (which will be discussed below). In this relatively simple example, t0 is at four in the morning local time, and the determinations of estimated road usage and desired pattern of road usage are made for a twenty four hour period. Alternatively, estimation of usage and desired usage may be made more frequently, or even on an ongoing and relatively continuous (that is, “real time” basis).

The set of roads are roads that are suitable for vehicle travel. They may be subject to transient conditions which slow or block the roads. The set of roads may or may not include all roads in a local area. The set of roads may be distributed over an area greater than a local area (for example, all the nationally-administered highways of a nation state). For tolling purposes, the road may be broken into road portions, as will be shown and discussed, below, in the following sub-section of this Detailed Description section. The set of roads is extensive enough that at least some authorized vehicles will have multiple choices about how to travel from an “origin location” to a “destination location.”

As will be seen, this embodiment of the present invention is designed to leverage the desire of vehicles to save money on tolls (in the case of positive tolls), or to make money on tolls (in the case of negative tolls) such that the vehicles tend to travel over the set of roads in a socially desirable distribution. This socially desirable distribution refers primarily to geographical distribution (that is, the choice of road portions, from among alternatives) that a vehicle makes, but also may refer to time distribution (that is, travel time within a day, travel time within a week or month). The distribution of vehicles over the set of roads is sometimes referred to herein as “traffic flow.” There are several types of traffic flow, such as projected (or “estimated,” “estimated” in this context will generally herein refer to estimations of future behavior) traffic flow, actual (or “observed”) traffic flow and desired traffic flow.

In this embodiment, the following input data is used to determine estimated traffic flow: (i) historical traffic flow data (normalized to get rid of the effect of tolls charged); (ii) data from businesses concerning projected shipping levels; (iii) data from business concerning employee shift schedules; (iv) data concerning scheduled special events (such as sporting events); (v) data from educational institutions regarding student and teacher schedules; and (vi) data from retail stores concerning planned hours of operation. Additionally and/or alternatively, other types of input data could be used as a basis for determining the estimated traffic flow on the road portions of the set of roads. In this embodiment, the traffic flow is estimated for 24 hour periods. Alternatively, traffic flow may be estimated each time a vehicle enters an origin and destination for a planned journey. If the traffic flow is estimated each time a journey is planned and tolls are requested then: (i) there will tend to be a much smaller time lag between the estimation of traffic and the time the vehicle will actually be driving on the road segments; (ii) data relating to actual traffic conditions at the time of calculation of the toll may become an important basis or partial basis for traffic estimation; and (iii) this use of actual existing traffic conditions at the time of toll calculation may enable much more efficient and/or effective control of resultant traffic patterns.

This document does not attempt to answer, for all intents and purposes, what a socially desirable traffic flow is, and, it should also be kept in mind that what is socially desirable may change over time and/or change with road and/or vehicle technology. However, when a current idea of socially desirable traffic flow is agreed upon by appropriate authorities, various embodiments of the present invention can help make that socially desirable traffic flow happen (or, at least, come closer to happening). If the concept of socially desirable traffic flow changes over time, then various embodiments of the present invention can help incentivize actual track flow to track that change (again, at least to some extent). Various embodiments of the present invention may even be useful in helping determine what a socially desirable traffic flow is because the tolls of the present invention would allow some experimentation and empirical observation of the resulting “experimental” traffic flow.

In this simple example, the set of vehicles to which the tolls apply are commercial freight carrying vehicles (some with drivers and some being remote control driverless vehicles). Some of these vehicles have their travel times and routes determined by humans, while other vehicles have their travel times and routes determined by machine logic (for example, software running on hardware). Alternatively, some embodiments of the present invention may apply more broadly to all vehicles, including personal vehicles in private, non-commercial use. It will be understood by those of skill in the art that the more vehicles that are subject to the tolls, the more influence that can be exerted over the total traffic flow by intelligent setting of tolls according to various embodiments of the present invention.

In this embodiment, the following input data (referred to herein as “behavior change factors”) is used to determine socially desirable traffic flow: (i) origin-destination traffic flow (and its elasticity) that should be satisfied (this can be computed through traffic models and surveys); (ii) how well the vicinity of a road portion can handle air and/or noise pollution (for example, a road portion near a school for small children is a relatively bad place to create a relatively large amount of pollution); (iii) construction projects (for example, is a road portion partially closed down and likely to lead to congestion); (iv) historically observed congestion on a road portion at certain times of the day or week; (v) fuel usage intensivity (for example inclines or curves) of the road portion; (vi) durability/life expectancy of the road portion; (vii) affect of congestion on the road portion with respect to congestion on other road portions; (viii) law enforcement and/or emergency services imperatives; (ix) non-vehicular (for example, pedestrian) traffic; (x) bus routes; (xi) expected weather conditions that can cause congestion; and/or (xii) historically observed accident rates for a road portion. Additionally and/or alternatively, other types of input data could be used as a basis for determining the socially desirable traffic flow on the road portions of the set of roads.

The “behavior change value” determination(s) of step S52, mentioned above, will now be discussed in more detail. Behavior change factor value determination is performed by: (i) comparing the difference (“delta”) between the estimated traffic flow and the socially desirable traffic flow for each road portion for each hour of the coming twenty-four hour period; and (ii) assigning a behavior change value to each road portion for each hour, with the size of the behavior change value being correlated with the size of the associated delta for that road portion and time period. In this simplified example: (i) when the delta is zero or negative (that is, expected traffic flow is less than socially desirable traffic flow) then the behavior change value is zero; and (ii) when the delta is positive, then a positive behavior change value (or “term”) is defined for the associated road portion and hour of the day. In this simple example, (positive) tolls will only be charged for road portions and associated times having non-zero behavior change values, and the size of the toll for driving on the associated road portion at the associated time will positively correlate (as further discussed below) to the size of the behavior change value.

As a final note on step S52, it is noted that the estimated and socially desirable traffic flows are determined with reference to all vehicular traffic on the roads, while the tolls of this embodiment are charged only to a subset of vehicles (that is, commercial freight vehicles). Other embodiments may have a greater degree of congruence between the traffic used to determine estimated and/or desired flow and the traffic to which the tolls actually apply.

Processing proceeds to step S54 where, at time t1, vehicle interface mod 79 receives registration information through network 15 from first vehicle sub-system 17 (see FIG. 1). Vehicle sub-system 17 is a commercial freight vehicle with a GPS and a human driver. In this example, time t1 is 4:10 am. Vehicle interface mod 79 requests, through network 15, the first vehicle's origin, destination and other info as will be discussed, below, in connection with step S56.

Processing proceeds to step S56, where the driver provides certain information back to mod 79 over network 15. In this embodiment, this information includes the planned origin, the planned destination, planned trip departure time, information about the vehicle's characteristics, information about the driver's freight and information about the supplier and recipients of the freight. In this example, the planned departure is 4:35 am.

Processing proceeds to step S58, where toll determination mod 81 algorithmically determines, by machine logic, a first set of tolls for the trip planned by the first driver in first vehicle sub-system 17 (see FIG. 1). This set of tolls will provide tolls for all road portions that the driver may take in his journey along any of the multiple, alternative routes he may take from his origin to his destination location. Some, or many, of the road portions may have a zero toll. In fact, because he is leaving at 4:35 am, his tolls may be low in general, as congestion tends to be less at such an early hour. However, when the set of tolls are calculated, it is likely that some routes will incur greater (positive) tolls than others.

In determining the set of tolls, four categories of factors are considered by the toll setting algorithm of mod 81: (I) behavior change factors; (II) characteristics of the driver's vehicle; (III) characteristics of the vehicle's freight; and (IV) characteristics of the supplier/recipient of the freight. The category of behavior change factors has already been discussed above. The other three categories of factors will be discussed over the following several paragraphs.

Category (II): Vehicle Characteristics. These factors are chosen so that tolls can be set with an appropriate view to relevant, or pertinent, characteristics of a vehicle for which the set of tolls is being determined. This category includes two sub-categories as follows: (a) vehicle type characteristics; and (b) vehicle specific characteristics. These two sub-categories will be respectively discussed.

Sub-Category (a): Vehicle Type Factors. Vehicle type factors are characteristics of a vehicle that: are relevant for toll purposes; and cannot be easily modified on a vehicle by vehicle basis. As a simple example of this, a ten axle freight truck will take up more space on the road than will a two axle freight truck, so a higher toll would be charged to the ten axle truck (although the relative toll increase should not be so large that inefficient deployments of multiple smaller trucks are made in place of the large truck). In this embodiment, the vehicle type factors are as follows: (i) number of axles; (ii) motor rated (as opposed to, observed, or measured) horsepower; (iii) vehicle height; (iv) wheel base width; (v) vehicle fuel type; and (vi) driver or driverless vehicle. These vehicle type characteristic factor values can be automatically communicated to the toll server, without the driver having to type them in, because vehicle type characteristics do not change from one journey to the next. Alternatively, or additionally, other vehicle type factors may be used, and this will be especially true in embodiments not limited to commercial freight vehicles. Alternatively, there may be no vehicle type factors considered.

Sub-Category (b): Specific Vehicle Factors. Specific vehicle factors are characteristics of a vehicle that: are relevant for toll purposes; and can vary, or be modified, on a vehicle by vehicle basis. As a simple example of this, a production line freight vehicle may be modified to add regenerative braking and associated additional electrical energy storage (for example, batteries). In this embodiment, the specific vehicle factors are as follows: (i) regenerative braking; (ii) electrical energy storage capacity; (iii) measured emissions from latest vehicle inspection; (iv) horn volume; and (v) tire type. The driver may need to supply values for these specific vehicle characteristic factors because these values may change frequently as the freight company performs routine maintenance and/or modifications on its fleet of vehicles. Alternatively, or additionally, other vehicle type factors may be used, and this will be especially true in embodiments not limited to commercial freight vehicles. Alternatively, there may be no specific vehicle factors considered.

Category (III): Freight Factors. In this example, certain kinds of freight are determined to be more socially desirable than others. In this example, the freight factors are determined as follows: (i) most freight is assigned a zero freight factor value that does not affect any tolls; (ii) freight in the form of fresh vegetables is assigned a negative freight factor value that will tend to decrease tolls; and (iii) freight in the form of high fat and carbohydrate snacks is assigned a positive freight factor value that will tend to increase tolls. Alternatively, other freight type factors may be used. For example, vehicles transporting school children may qualify for reduced tolls. As a further alternative, there may be no freight factors considered.

Category (IV): Supplier/Recipient Factors. In this example, certain kinds of freight suppliers or recipients are determined to be more socially desirable than others. In this example, the freight supplier recipient factors are as follows: (i) if freight supplier qualifies as a small business then a first negative toll term is applied in order to reduce tolls; (ii) if freight recipient is a charity then a second negative toll term is applied in order to reduce tolls; and/or (iii) if freight supplier or recipient is a qualifying educational institution then a third negative toll term is applied in order to reduce tolls. As a further example, if the toll system applied more broadly to all vehicles, then police owned vehicles might be assigned a large negative toll term to wipe out any tolls that these vehicles might otherwise incur. Alternatively, other supplier/recipient factors may be used. As a further alternative, there may be no supplier/recipient factors considered.

In other embodiments, alternatively, or additionally, other categories of factors may be used. One example of another category is vehicle and/or driver driving history. For example, if a given vehicle has a history of driving on congested roads, notwithstanding the tolls charged, then that might be a factor used to increase tolls (on the theory that the vehicle requires additional incentivization for a behavior change). As a further example of another category, factors related to the costs of building and/or maintaining a given road portion might be considered—indeed this is a category of factors that is considered, or at least claimed to be considered, in setting traditional tolls.

The toll setting algorithm of mod 81, which will be explained presently, is highly simplified for pedagogical purposes. More complex toll setting algorithms will be discussed, below, in the next sub-section of this Detailed Description section. In this simple example, the toll setting algorithm structured and/or programmed into mod 81 includes Steps (1) to (5), which will respectively be discussed in the following five (5) paragraphs.

Step (1): determine all road portions of all possible routes (or all likely routes) for the vehicle's journey from its origin location to its destination location. This is herein called the “road portion set.” In this embodiment, the toll determination is made not only on a vehicle by vehicle basis, but also on a journey by journey basis (with the journey basis including origin, destination, travel time and travel date). In other embodiments the toll determination may be made on a journey by journey basis, but without any variations that depend upon the vehicle, its freight or parties related to the vehicle or its freight—in these variations, the toll determination is journey by journey, but not vehicle by vehicle. In still other embodiments the toll determination may be made on a vehicle by vehicle basis, but without any variations that depend upon the origin, destination, travel time or travel date of the journey—in these variations, the toll determination is vehicle by vehicle, but not journey by journey.

Step (2): retrieve base toll values (or terms, herein called Bn, where n is the road portion number from 1 to N for N total road portions) for road portions of the road portion set. These values are stored in a table (not separately shown in FIG. 3). In this simple example, all the base toll terms are zero tolls or positive tolls, and the base toll terms do not change with travel time or travel date. Base toll terms may exist, for example, when tolls according to the present invention are engrafted onto a system of roads which include road portions (for example, bridges) that have pre-existing tolls. It may not be feasible to change or decrease the pre-existing tolls, so these might be maintained as base toll term in a toll determination algorithm according to the present invention. Alternatively, some embodiments of the present invention may not include a base toll term.

Step (3): retrieve behavior change toll values (or terms, herein called Cn, where n denotes a road portion number from 1 to N for N total road portions) for road portions of the road portion set. These values are stored in a table (not separately shown in FIG. 3). In this simple example, all the behavior change toll terms are zero tolls or positive tolls, and these terms were calculated for the current twenty-four hour period back at step S52. The behavior change toll terms, therefore, are specific to the travel date and travel time. In fact, in some cases, these behavior change toll terms may cause the driver to change his initially preferred travel date and/or travel time (presumably and hopefully in a way that is socially beneficial).

Step (4): calculate vehicle characteristics term (herein called V). The vehicle characteristics information received at step S56 and the vehicle characteristics factors are used to calculate a vehicle characteristics term.

Step (5): calculate freight characteristics term (herein called F). The vehicle characteristics information received at step S56 and the freight characteristics factors are used to calculate a freight characteristics term.

Step (6): calculate supplier/recipient characteristics term (herein called S). The vehicle characteristics information received at step S56 and the freight supplier/recipient characteristics factors are used to calculate a recipient characteristics term.

Step (7): combine the various terms to calculate the set of tolls (herein called Tn for road portions 1 to N). In this simple example, the terms are combined, to calculate each toll of the set of N tolls, according to the following formula: Tn=Bn+Cn*(V+F+S), where if Tn<0, then Tn is set to zero. Note that the size of the toll is positively correlated with the behavior change terms, the vehicle term, the freight characteristics term and the supplier recipient term. This simple example reflects just one possible way to combine the terms. For example, it would also be possible to use the behavior change terms, vehicle characteristics term, supplier recipient term and/or freight characteristics term as exponential terms, logarithmic terms, factorial terms, terms in complex polynomial relations, terms in calculus-based relationships and so on. Some more alternative toll calculations will be discussed, below, in the next sub-section of this Detailed Description section. It is noted that this simple algorithm, of the present example, would incentive changes in route-choosing on the part of drivers and other route-setting decision-makers because: (i) on road portions with behavior change factors of zero, there would be no tolls (except base tolls, if any); and (ii) on road portions with positive behavior change factors, the tolls would increase in geometric proportion with the behavior change term that reflects due consideration of the behavior change factors.

Processing proceeds to step S60, where vehicle interface mod 79 communicates these tolls to vehicle sub-system 17 for visual presentation to the driver on a display screen (not separately shown). In this embodiment, the display shows a map with nodes interconnected by road portions, and with the various road portions showing the tolls of the toll set determined at step S58. The visual display may also show total tolls for several likely routes from the driver's chosen origin to the driver's chosen destination. Other forms of presentation of the tolls (visual and/or non-visual) to the driver are possible. Alternatively, route setting may be performed by machine logic (for example, route setting software that may be present in vehicle sub-system 17), in which case the toll set would not need to be converted into human readable form. In this example, the driver is presented the toll set display at t2=4:20 am (between t1 and t2: (i) the driver enters trip, vehicle and freight info, and (ii) mod 81 calculates the toll set).

The process proceeds to step S62, where the driver of first vehicle sub-system 17 chooses his route for his journey. The driver might, or might not, choose the route with the lowest tolls, but there is at least some financial incentive for the driver to choose a relatively inexpensive route. In this embodiment, the driver actually communicates the chosen route back to vehicle interface mod 79 so that the driver can be sent a warning if the vehicle is detected (by its GPS (not separately shown in the Figures) and program 75 working co-operatively) to have unintentionally, or carelessly, departed from his chosen route. Alternatively, in some embodiments, the driver does not need to report his planned route back to program 75.

The process proceeds to step S63, when the driver starts his journey from the origin to the destination over the chosen route, with his progress being tracked by GPS and intermittent communications over network 15 with track/charge module 83. In this example, the driver starts his journey at t4=4:35 am, which is exactly the time that the driver communicated as the staring time back at S56. Because the driver follows his chosen route, mod 83 charges the freight company's account exactly the tolls that the driver would expect based on the choice of route the driver made at S62. In this embodiment: (i) the driver does not need to take any affirmative action to pay the tolls; but (ii) the driver does get a report of the tolls charged when he finishes his trip (at t5=6:54 am) for auditing and record-keeping purposes.

### III. Further Comments and/or Embodiments

Some embodiments of the present invention may include one, or more, of the following features, characteristics and/or advantages: (i) use of GPS measurements to obtain GPS-based traces for use in road toll (sometimes herein referred to as “charges”) computation; (ii) collection of tolls at multiple network locations; (iii) application of different tolls to different users of the same road; (iv) setting of tolls in a way that optimizes reduction of road congestion; (v) setting of tolls based on trajectories of vehicles on the roads (this is sometimes referred to herein as “Lagrangian pricing model”); (vi) an analytical expression of the set of available prices in a trajectory-based pricing model; and/or (vii) an algorithm for minimizing total tolls charged.

The recent improvement and democratization of real-time positioning capabilities using GPS devices creates new possibilities and challenges for congestion pricing. Charging users based on their path properties and as a function of their origin and destination, and not only on a sparse set of locations on the road network, is now possible. In a practical setting, it is also possible to account for additional personalized criteria; a pricing scheme should be clear and understandable for the driver, it should be robust to positioning errors, hence should not vary significantly in time or in space, and it should be “fair”, which means that tolls charged should be reasonably similar for similar paths and acceptable for the driver. Some embodiments of the present invention characterize feasible Lagrangian (trajectory-based) toll sets achieving a given flow allocation on the network.

Some embodiments of the present invention: (i) effectively demonstrate specific properties of the available pricing schemes, such as the equivalence between path pricing and commodity pricing under certain assumptions; (ii) focus on “smarter pricing” and specifically on the vehicle-by-vehicle pricing of tolls; (iii) provide results on the size of the sets of available prices for specific preferences of the pricing scheme operator; (iv) provide an algorithm to construct a pricing scheme for different strategies; (v) assess the performance of our pricing schemes using benchmark pricing algorithms; and/or (vi) use numerical simulations and analyze performance in Python using a convex optimization library.

In the following discussion, it is assumed that the system is static in the sense that variables are not time dependent. A road network is represented as a directed graph G=( [symbol] , [symbol] ) where [symbol] are the nodes (intersections) and [symbol] are the arcs (segments) of the graph. K is denoted as the set of origin-destination (OD) pairs (k is a pair of nodes, usually denoted k=(p,q),p,qε [symbol] ), and (dₖ)_{kεK} is the associated travel demand for pair k. The traffic flow from a point A to a point B is defined as the number of vehicles traveling from A to B. Several representations of the traffic flow on the network can be used.

Path flows will now be discussed. For k=(p,q)εK, let [symbol] ₖ (or equivalently [symbol] _{(p,q)}) denote the set of directed acyclic paths in G connecting the origin p with the destination q, and let [symbol] :=∪_{kεK} [symbol] ₖ. [symbol] is the set of all acyclic paths of the network linking the OD pairs K. A path flow is defined by the vector of the value of the flows: h=(hᵣ)_{rε} [symbol] on each route rε [symbol] . As a flow, h must respect the constraint of positiveness and satisfy demand, as shown below in the Expressions (1a) and (1b):

$$\begin{matrix}\begin{matrix}{\sum }_{r ∈ {ℛ}_{k}} {h}_{r} = {d}_{k} & ∀ k ∈ K\end{matrix} & ( 1 a ) \\ \begin{matrix}0 \leq {h}_{r} & ∀ r ∈ ℛ .\end{matrix} & ( 1 b )\end{matrix}$$

A flow h satisfying (1a) and (1b) is called feasible. H represents the set of feasible path flows. Variable Γ represents the OD-paths incidence matrix, for which for (r,k)ε [symbol] ×K coordinates of the matrix, (Γ)_{r,k}=δ_{rε} [symbol] _{ₖ} with δ being the Kronecker symbol. This means that expressions (1a) and (1b) can be rewritten as Expression (2):

Γ^{T}h=d

0≦h.

Let he H be a feasible flow. [symbol] ^{h-eff} is the subset of [symbol] composed of all the paths for which the flow h is positive, and [symbol] ^{k,h-eff}= [symbol] ^{h-eff}∩ [symbol] ₖ defines the set of paths of the OD pair k for which the flow h is positive. [symbol] _{i,j} represents the set of paths from i to j. [symbol] _{i,j}^{h-eff} represents its restriction to the paths for which the flow is positive. [symbol] _{i,j}^{k,h-eff} represents its restriction to the paths for which the commodity flow of OD pair k is positive.

Commodity arc flows will now be discussed. Let wₐ^{k} be the flow of vehicles from OD pair k=(p,q) going through arc a, and w^{k} the vector of arc flows for OD pair k. In this context, k is a commodity and w^{k} an OD-flow or commodity-flow.

A flow w is called feasible if it is a positive flow and if each commodity flow w^{k} satisfies the Kirchhoff node rule with exogenous flows equal to the traffic demand. E represents the node-arc incidence matrix, for which component: (i) E_{i,a}=1 if node i is the destination node of arc a, (ii) E_{i,a}=−1 if i is the origin node of arc a, an (iii) E_{i,a}=0 otherwise. For k=(p,q), i^{k}ε [symbol] ^{|} [symbol] ^{|} the node-OD incidence vector is such that (i) nε [symbol] , iₙ^{k}=+1 if n=q, (ii) iₙ^{k}=−1 if n=p, and (iii) iₙ^{k}=0 otherwise. As shown, below by Expressions (3a) and (3b), w is feasible if and only if:

Ew^{k}=dₖt^{k}∀kεK (3a)

0≦w^{k}∀kεK. (3b)

W is the set of feasible commodity flows, that is flows respecting (3a) and (3b). E is denoted by the following Matrix (1):

$$( \begin{matrix}E & 0 & & … & 0 \\ 0 & E & & … & 0 \\ & & … & & \\ 0 & 0 & & … & E\end{matrix} )$$

In Matrix (1), \tilde{E}w=(dₖiₖ)_{kεK}. Commodity arc flows from the path flows are computed according to Expression (4):

$${w}_{a}^{k} = {\sum }_{e ∈ {ℛ}_{k} , a ∈ r} {h}_{r} . \qquad ( 4 )$$

Arc flows will now be discussed. An aggregate flow f=(fₐ)_{aεA} is defined on each arc a of the network by fₐ=ΣₖWₐ^{k} sum of all the commodity flows: for a given arc a, fₐ is the total traffic flow on the arc. The vector of arc flows f is positive and satisfies the Kirchhoff node rule. It can be computed from h or w as shown by expressions (5), (6), (7) and (8):

$$\begin{matrix}\begin{matrix}{f}_{a} = {\sum }_{r ∈ ℛ , a ∈ r} {h}_{r} & ∀ a ∈ 𝒜\end{matrix} & ( 5 ) \\ f = Λ h & ( 6 ) \\ \begin{matrix}{f}_{a} = {\sum }_{k} {w}_{a}^{k} & ∀ a ∈ 𝒜\end{matrix} & ( 7 ) \\ f = {\sum }_{k} {w}^{k} , & ( 8 )\end{matrix}$$

In the foregoing Expressions (5) to (8), A is the arc-paths incidence matrix and (Λ)_{a,r}=δ_{aεr}, A flow f is called feasible if it is the sum of feasible commodity flows w^{k} or if it is the sum of feasible path flows h. Variable F represents the set of feasible flows f.

The three flows f, wk, k K are properly characterized as being “h equivalent” if: (i) f and w can be computed from h using Expressions (4) and (6), and (ii) one of the three given flows is well defined (that is, feasible). Finally, the generic notation v=(vi)i I denotes the arc, path or commodity formulation. Some additional variable definitions are as follows: (i) V denotes the set of feasible flows v, (ii) n=|I| denotes the total number of traces on which v is defined, (iii) A corresponds to the matrix E in commodity arc flow notation or to ΓT in path flow representation, and (iv) p is the number of rows of A (|K| if V=H and |N| if V=W). These notations are summarized in the following Table 1:

TABLE 1
Flow notations

| | Path flow | Multicommodity arc flow | Aggregate arc flow | Generic notation |
|---|---|---|---|---|
| Set on which flow is | [symbol] | [symbol] × K | [symbol] | l |
| defined | | | | |
| Size of this set | \| [symbol] \| | \| [symbol] \|\|K\| | \| [symbol] \| | n |
| Flow | h = (hᵣ)ᵣ | w = (wₐ^{k})_{k,a} | f = (fₐ)ₐ | v = (vᵢ)ᵢ |
| Set of feasible flows | H | W | F | V |
| Link with path flow | | | Λ | |
| Matrix of equality | Γ^{T} | \tilde{E} | | A |
| constraints | | | | |

The expression aε [symbol] , lₐ(·) represents the “latency function” of arc a. Variable lₐ(fₐ) is the travel-time experienced by a driver on arc a when the traffic flow on this arc is fₐ. Some embodiments of the present invention assume that lₐ is a non-decreasing function of fₐ on an interval [0,cₐ], where cₐ is the supremum of the possible values of the flow on a, also called capacity of the link.

The American Bureau of Public Roads (BPR) model of latency functions reads as follows:

$${l}_{a} ( x ) = {t}_{a} \cdot ( 1 + 0.15 \frac{{x}^{4}}{{c}_{a}^{4}} ) ,$$

where tₐ is the free-flow travel-time, equal to lₐ(0). The “global cost” or “system cost” of the flow ν is noted C(ν) and represents the total travel costs experienced by the users. A generic notation for the global cost in the untolled case reads as follows:

C=ν^{T}l(ν)

Given i, which represents a path (or arc or commodity arc), the contribution of traffic flow on i to the global cost C defines a function cᵢ(ν). For the model without tolls, cᵢ(ν)=νᵢlᵢ(ν), which is the travel time experienced on trace i summed over all flows going through i.

In the following discussion, it is assumed that latency functions are convex and non-decreasing.

Given a traffic demand d and latency functions 1 on a network, the “social optimum” (SO), can be expressed as f* in term of flows on arcs, or h* in term of flows on paths. The SO is defined as the solution to the following set of equations:

$$\begin{matrix}{min}_{f ∈ ℱ} C ( f ) & where C ( f ) = {\sum }_{a ∈ 𝒜} {f}_{a} {l}_{a} ( {f}_{a} ) \\ {min}_{h ∈ ℋ} C ( h ) & where C ( h ) = {\sum }_{r ∈ R} {h}_{r} {l}_{r} ( {h}_{r} ) ,\end{matrix}$$

In a standard form, this can be rewritten as Expression (9):

$${min}_{𝓋 ∈ V} C ( v ) . \qquad ( 9 )$$

If the latency functions are differentiable, and if C is convex, an SO can also be written with a condition on the derivatives of the latency functions. A flow is locally optimal if and only if moving flow from one path to another can only increase the flows cost. A characterization of this local optimum is given by the following Expression (10):

$$∀ i , j ∈ I , v ∈ V , \frac{\partial {c}_{i}}{\partial {v}_{i}} ( v ) \leq \frac{\partial {c}_{j}}{\partial {v}_{j}} ( v ) . \qquad ( 10 )$$

If the cᵢ are convex, C is convex and the local optimum is a global optimum. Expression (10) is a necessary and sufficient condition for v to be solution of the SO problem. If the cᵢ are convex, there will be equivalence between Expression (9) and the first-order optimality condition. Variable ν* is optimal if and only if the following Expression (11) is met:

∀νεV,∇C(ν*)^{T}(ν−ν*)≧0. (11)

Expression (11) is a “variational inequality problem” (VIP) formulation equivalent to Expression (9).

A solution f* of the SO-arc problem can correspond to several solutions h*. This can be illustrated as follows: if two drivers a and b with different OD-pair can take two different paths r and s between node i and node j, the solution for which a takes path r and b takes path s and the solution for which a takes path s and b takes path r are equivalent from the perspective of total travel time.

The “user equilibrium,” also known as “Wardrop equilibrium” (or “Nash equilibrium” in the case of a finite number of players), is a steady-state of traffic on the network respecting “Wardrop's first principle.” In some embodiments of the present invention, this principle can be expressed as follows: for drivers with the same OD-pair the journey times on all the routes actually used are equal, and less than those which would be experienced by a single vehicle on any unused route. At equilibrium, no driver can decrease his travel time by choosing another path. The mathematical translation leads to the following definition of user equilibrium: a flow hεH is a “user equilibrium” if for every kεK and r,sε [symbol] ₖ with hᵣ>0, lᵣ(h)≦lₛ(h). The similarity of this problem with Expression (10) leads to a result that will be discussed in the following paragraphs.

Assume latency functions lₐ, aε [symbol] are non decreasing, and let f be a feasible arc flow which is a user equilibrium for a graph [symbol] with these latency functions. Then f is a social optimum for graph [symbol] , with cost functions hₐ(fₐ)=∫₀^{fa}lₐ(x)dx.

Let f be a feasible arc flow which is a social optimum in graph [symbol] with convex and differentiable cost functions cₐ, aε [symbol] . Then f is a user optimum for graph [symbol] , with latency functions c′ₐ.

The functions hₐ, aε [symbol] are primitives of the lₐ. According to the definition of a “user equilibrium,” as set forth above, if f is a UE for the lₐ, the hₐ verify Expression (10) at f. As their derivatives are non-decreasing, the hₐ are convex and, hence, f is solution of the SO problem.

As f is a SO for the convex, differentiable functions cₐ, aε [symbol] , they verify equation 10, so that their derivatives define exactly a UE for f.

In the simple untolled model, c′ₐ(fₐ)=lₐ(fₐ)+fₐl′ₐ(fₐ). It differs from the user equilibrium problem only through the second term fₐl′ₐ(fₐ), which is called “external marginal cost.”

Further information can be deduced from the foregoing paragraphs. A user equilibrium flow is solution to the following convex program as follows:

$${min}_{f ∈ F} {\sum }_{a} {\int }_{0}^{{f}_{a}} {l}_{a} ( x ) d x .$$

A flow ν is a user equilibrium if and only if it satisfies the following variational inequality problem:

∀νεV,l(ν*)^{T}(ν−ν*)≧0.

An upper bound to the price of anarchy, defined as the ratio of the cost of a user equilibrium and the social optimum, expressed as (1−ν( [symbol] ))⁻¹ in the case of continuous, non-decreasing latency functions, and where ν( [symbol] ) has an analytic expression and depends only on the family of latency functions used in the network has been obtained.

Traffic demand is called elastic if the OD pair flow demand d may depend of the traffic costs on the flow as shown by Expression (12):

d=(Dₖ(π_{q}^{k}−πₚ^{k}))ₖ, (12)

where π is the vector defined in the commodity arc flow KKT conditions (π_{q}^{k}−πₚ^{k} is the cost of travelling from p to q) and D(·)=(Dₖ(·))ₖ is a vector of non-increasing functions of demand per OD-pairs. If Expression (12) is added to the constraints of each of the representations, this results in demand-varying user equilibrium problems. Taking demand variations into account provides a more accurate model of user behavior. Assuming alternative travel modes are available, a driver may not want to use his private vehicle if tolls are too high. The reduction of total traffic demand may be a negative point in the pricing process; it may also be one of the objectives of the road network operator.

An elastic demand user equilibrium (ED-UE) problem can be formulated as follows:

$${min}_{w , f , d} {\sum }_{a} {\int }_{0}^{{f}_{a}} {l}_{a} ( x ) d x - {\sum }_{k ∈ K} {\int }_{0}^{{d}_{k}} {D}^{- 1} ( x ) d x$$

$$w \geq 0$$

$$f = {\sum }_{k} {w}^{k}$$

$$∀ k ∈ K , {Ew}^{k} = {\tilde{d}}_{k} .$$

Variable ED represents the set {(ν,d)|νεV, Aν=d}. The VIP formulation of this problem involves finding ( ν̅, d̅)εED such that the following Expression (13) is met:

l(ν)T(ν− ν̅)−D⁻¹(d)^{T}(d− d̅)≧0∀(ν,d)εED. (13)

A standard approach to congestion pricing consists in creating a tolled user equilibrium, which is a steady state of traffic, coinciding with the social optimum. In this portion of the discussion, it is assumed that all users have the same value of time, so that in a pure user equilibrium, enforcing a toll at a road of the network is equivalent to adding a certain delay to the experienced travel time on the corresponding arc of the graph (that is, the road map).

Let ρ be the vector of prices (expressed as a delay) on every element of the flow representation, νεV the corresponding flow vector, the effective travel cost experienced by the users being l(ν)+ρ. The corresponding convex optimization problem, using Beckmann's formula, is the following Expression (14):

$${min}_{f \geq 0 , v ∈ V} {\sum }_{a} {\int }_{0}^{{f}_{a}} {l}_{a} ( x ) d x + {ρ}^{T} v .$$

Equivalently, in terms of KKT conditions, the resulting flow is characterized by:

(l(ν)+ρ−A^{T}ν)≧0″

ν^{T}(l(ν)+ρ−A^{T}ν)=0

νεV,

or equivalently, using a variational inequality characterization, a tolled user equilibrium ν* is given by the following Expression (15):

∀rεV,(l(ν*)+ρ)^{T}(ν−ν*)≧0. (15)

When the latency functions are strictly monotonic, the solution v to the toll-user equilibrium is unique and the set of valid flow vectors is a “singleton.” Assuming that the latency functions are strictly monotonic, the “simple toll problem” can be defined as follows:

$$Find {v}^{*} , ρ such that \text{:} \{ \begin{matrix}{v}^{*} is a solution of {min}_{v ∈ V} C ( v ) \\ ∀ v ∈ V , {( l ( {v}^{*} ) + ρ )}^{T} ( v - {v}^{*} ) \geq 0\end{matrix} .$$

Basic solutions to the congestion pricing problem may not be acceptable from the perspective of the users, because of some issues that will be identified in the following paragraphs.

High tolls: Tolls raised on a given path may be low for some OD pairs and excessive for others. This is related to the issue of unfair travel-time, given that for a fixed OD pair, the total costs of all paths are equal at UE, so that paths with low travel times have high costs and paths with high travel times have low costs.

Spatial and temporal consistency: Tolls should not exhibit sharp variations in space, in order to reduce sensitivity to GPS errors. Tolls should not vary sharply in time as well, so that users can plan their trip ahead.

Total costs control: The effective total cost for the toll system is C^{ρ}=ν^{T}(l(ν)+ρ). One could expect that this new total cost should not exceed (or exceed too much) the pure user equilibrium global cost C^{UE}, in order to guarantee that toll pricing has a real value. However, unlike travel times, tolling cost ν^{T}ρ does not represent a real resource consumption (besides the cost of maintenance of the system) and can be reused efficiently. However, the set of valid tolls should not be too large. A formulation addressing this issues proposes to minimize the total amount of positive tolls, i.e. ν^{T}ρ, which leads to the problem known as MINSYS.

Number of tolled arcs: In the case of an infrastructure-based pricing system, a practical constraint to take into account is the number of toll stations. This number can also become the objective function to minimize, in order to reduce maintenance costs.

Lagrangian pricing schemes, potential pricing and some example results on the mathematical theory of commodity-based potential pricing will be discussed in the following paragraphs.

The problem of congestion toll pricing, as defined above, consists of finding a vector of tolls ρ such that the tolled user equilibrium is a social optimum, in the specific case of multi-commodity tolls. In some embodiments of the present invention, for a given flow allocation, the set of valid multi-commodity tolls (such that the tolled user equilibrium corresponds to this flow) can be expressed as the sum of: (i) the opposite of travel time on the arcs; (ii) any potential field defined on the nodes of the network for each commodity (or, more precisely, the potential difference between the end node and the start node of the arc); (iii) any positive toll on the arcs where the flow vanishes (this is further discussed, below). This result relates to the observation that adding a potential field to a valid toll vector does not change the route choice of commuters. Indeed, additional tolls corresponding to a potential field do not impact the relative travel costs between alternative paths and hence, do not modify the route choice of the commuters and the equilibrium. Based on this result, some embodiments of the present invention involve new pricing schemes made possible by this expression of multi-commodity tolls. In some embodiments of the present invention, and as will be further discussed below, tolls are constrained to be positive on each commodity-arc. If the commodity flows are acyclic, it is possible to construct a potential field always decreasing in the direction of the flow, and, hence, to construct a positive multi-commodity toll vector.

Some embodiments of the present invention can be better understood through a constructive proof of the existence of such positive multi-commodity toll vectors, which provides an algorithm for the closed-form computation of a solution to the problem of minimizing the total amount of tolls with positive tolls on every commodity arc.

Variable w* represents the commodity flow at which we want to stabilize the tolled user equilibrium. The characterization of prices introduced in Equation (15) leads to the following equation:

W(w*)={ρ≧0|(l(w*)+ρ)^{T}(w−w*)≧0∀wεW}.

−l(f*) is a valid pricing to reach the flow w*, which leads to the following expression:

−l(f*)εW(w*).

Indeed, the travel cost on a given path for a user is 0 if the flow is f* so all paths have exactly the same travel costs. If the flow increases on a path between two nodes i and j, the travel costs on this path will become positive. Meanwhile, flow will decrease on another path so travel cost will become negative and users will be encouraged to take those other paths, alleviating the flow on the first path.

The toll set W(w*) is a shifted polyhedral cone. If f is the arc flow corresponding to w, then the equation of Expression (16) will hold:

W(w*)=−l(f*)+N(w*,W), (16)

where N(w*,W)={u≧0|(u)^{|}(w−w*)≧0∀wεW}.

“Potential pricing” involves pε [symbol] | [symbol] | as defined on the arcs of the network. There is a “potential pricing” if there exists a vector πε [symbol] | [symbol] | defined on the nodes of the network such that p=E^{T}π where E is the node-arc incidence matrix as defined above. Variable π is the price potential.

For a=(i,j) an arc joining the nodes i and j, πⱼ−πᵢ, p is a “shifted potential pricing” associated to ν if p is the sum of a potential pricing \tilde{E}π, of the opposite of the travel times on the arcs −l(w) and of positive scalars μₐ on the arcs for which νₐ=0. This may be expressed as p=p(w, π, μ). If p=\tilde{E}^{T}π is a potential pricing, the total tolls levied between two nodes i and j for commodity k is Λₖ=π_{q}^{k}−πₚ^{k} tolls do not depend on the path taken from i to j. With k=(p,q), we define Λₖ=π_{q}^{k}−ₚ^{k} the sum along a path of [symbol] ^{k} of the commodity arc potential pricing. This component of a shifted potential pricing does not depend on the path chosen.

The toll set W(w*) shifted by l(f) is the set of all prices that can be written as the sum of a “potential pricing” and of positive commodity tolls on each arc for which the corresponding commodity flow is null. Expressions (17), (18), (19) and (20) are as follows:

$$\begin{matrix}W ( {w}^{*} ) = - l ( {f}^{*} ) + Im ( {E}^{T} ) & ( 17 ) \\ + {vect}^{+} ( {e}_{a}^{k} , k , a s . t . {w}_{a}^{k} = 0 ) & ( 18 ) \\ W ( {w}^{*} ) = \{ {( - {l}_{a} ( {f}_{a}^{*} ) + ( {E}^{T} π ) a + {μ}_{a}^{k} {δ}_{{w}_{a}^{k} = 0} )}_{k ∈ K , a ∈ 𝒜} & ( 19 ) \\ \vert {μ}_{k}^{a} \geq 0 ∀ k ∈ K , a ∈ 𝒜 \} . & ( 20 )\end{matrix}$$

An expression of W(w) is given in Expression (16). W is the intersection of an affine set with the set of positive flows: W={w|\tilde{E}w=d\tilde{d}}I( [symbol] ⁺)^{|K|·|A|}. Let n=|K|·| [symbol] |.

If a,k are such that (w*)ₐ^{k}>0, then it is not possible to find λ≠0 such that λ((w*)ₐ^{k}−wₐ^{k})>0 for every wεW, as it is possible to choose wεW such that wₐ^{k}>(w*)ₐ^{k}uεW such that wₐ^{k}<(w*)ₐ^{k}. Hence, if w*>0, then {u≧0|(w*−w)^{T}(u)=0∀wεW}={u≧0|(w*−w)^{T}(u)=0∀wεW}={u≧0|w^{T}u=0∀w, \tilde{E}w=0}=ker\tilde{E}^{⊥}. Hence, N(w*,W)=(ker \tilde{E}^{⊥})⁺. N(w*,W) is the restriction to positive vectors of a vector space of dimension (n−dim (ker\tilde{E})).

Let I₀={(a,k)|wₐ^{k}=0} and suppose I₀ is not empty. Then the space of solutions is larger. More precisely, for iεI₀, ∀wεW, wᵢ−wᵢ*≧0. Hence, every uᵢ≧0 is a valid toll for trace i. Then N(w*,W)=ker(\tilde{E})^{⊥}+{Σμᵢeᵢ|iεI₀, λᵢ≧0}. As wᵢ* reaches a physical limit wᵢ*=0, the control operated through prices is relaxed and the i^{th}-component of the valid prices only has to be positive.

We also have W(w*)=−l(w*)+ker(\tilde{E})^{⊥}+vect⁺(eₐ^{k}(a,k)εI₀). A well known result of linear algebra states that ker(\tilde{E})^{⊥}=Im(\tilde{E}^{T})={\tilde{E}^{T}π,πε [symbol] ^{|} [symbol] ^{|·|K|}}.

If ν=w, for all kεK, π^{k} is a price potential on the arcs of the graph.

This theorem provides new alternative tolls for pricing users in order to reach the desired flow, and not merely an SO flow. Additionally, potential prices express valid tolls (after a translation by −l(w*)) that do not depend of the values of the flow in the network but only on its structure, hence provide greater robustness to measurement error. Finally, the valid tool set is simply expressed as an unconstrained vector space.

In the following section, we extend these results to the case of positive pricing in W(ν*). We also show that this pricing technique allows one to stabilize the network allocation around flows that are not stabilizable using a traditional positive arc pricing.

The objective of this section is to determine under which conditions we can find a pricing scheme such that a user of the network is never charged a negative toll.

“Acyclic flow” will now be defined. Let ν be a flow defined on the arcs of a network. Flow variable ν is “acyclic” if ν is not positive on all the arcs of a directed cycle of the graph [symbol] . It is equivalent to saying that the subgraph [symbol] _{ν} of [symbol] consisting of all arcs for which ν is positive is acyclic. Variable w is acyclic if the related commodity flows W^{k} are acyclic.

Optimal commodity flows are acyclic. If the latency functions of the network are increasing, for w a flow defining a user equilibrium or a social optimum, for each kεK, W^{k} is acyclic. It is also true if when considering the origin-based aggregation of commodity flows. w^{p}=Σ_{k=(p,q)εK}W^{k} is acyclic if w defines a user equilibrium or a social optimum.

An aggregate flow, even optimal, can be cyclic. Let f be an aggregate flow on a network where there are two symmetric OD pairs (p,q) with demand d and (q,p) with demand d. Then if r_{p,q}ε [symbol] _{p,q}^{h-eff} and r_{q,p} [symbol] _{q,p}^{h-eff}, f is positive on the directed cycle (r_{p,q},r_{q,p}).

Let variable ν be a positive flow defined on the arcs of the network, there exists a potential pricing in W(ν) strictly positive everywhere if and only if ν is acyclic. Suppose that ν is acyclic. Let [symbol] _{ν} be the subgraph of [symbol] defined by the arcs for which ν is strictly positive. In this case, [symbol] _{ν} is acyclic. In order to define a potential π on the nodes of [symbol] _{ν} such that for an arc a=i→j in [symbol] _{ν}, the difference πⱼ− [symbol] ᵢ is strictly positive. On the arcs of [symbol] \ [symbol] _{ν}, the constants μₐ can be defined positively, hence it is possible to balance the negative potential difference by a sufficiently large value of μₐ.

As [symbol] _{ν} is acyclic, it is possible to define a partial order on the nodes of [symbol] _{ν}: iπj if there exists a path from i to j in [symbol] _{ν}. It is noted that j=prec(i) if there exists an arc from i to j. Let [symbol] _{ν}=( [symbol] _{|} [symbol] ν, π) the set of nodes of graph [symbol] _{ν} equipped with the partial order π. Algorithm (1) (including Steps (1) to (5)) is then used to construct the potential field on the nodes of [symbol] _{ν} as follows:

### Step (1): Let E=Ø.

Step (2): Choose i a minimal element of [symbol] _{ν}\E.
Step (3): Define πᵢ=max 0,{ⱼ+ε|j=prec(i)} (j is necessarily in E as jπi).
Step (4): Update E=E Y {i}.
Step (5): If [symbol] _{ν}\E is empty, then break, but otherwise go back to Step (1).

As [symbol] _{ν} is partial ordered, this algorithm terminates, when E= [symbol] _{ν}. The correctness is given by the following invariant: ∀i, jΣE, iπj [symbol] πⱼ−πᵢ≧ε. Now suppose that there exists a potential pricing E π+μ in W(ν) strictly positive everywhere, and suppose [symbol] _{ν} contains a directed cycle i₀→ . . . →iₖ→i₀. Then μ vanishes on the arcs of this directed cycle (as it belongs to [symbol] _{ν}) and π is such that π₀< . . . <πₖ<π₀ which is absurd. Hence, if there exists a potential pricing strictly positive everywhere, [symbol] _{ν} is acyclic and the same holds for ν. Let ν be a feasible flow defined on the arcs of the network, acyclic, then there exists a positive shifted potential pricing in W(ν). This is shown by modifying Step (2) of Algorithm (1) to provide the following definition:

πᵢ=max 0,{πⱼ+lₐ(νₐ)|j=prec(i),a=(i,j)}.

Accordingly, the invariant becomes

$$∀ i , j ∈ E , i π j ⇒ {π}_{j} - {π}_{i} = max ( 0 , {l}_{r} ( v ) ) .$$

If w^{SO} is a multi-commodity flow solution of a SO problem, then the set of positive commodity toll vectors leading to w^{SO} is given by W (w^{SO})⁺=W(w_{SO})I [symbol] ⁺, for which an expression of W(w^{SO}) is given in the equation of Expression (17) and W(w^{SO})⁺≠φ. As for each commodity k, w^{k} is acyclic, the math set forth above: (i) proves that the set is “non empty;” and (ii) shows how to characterize the set.

Variable s(w) represents the pricing scheme constructed above. The corresponding price potential is defined by:

$${π}_{i}^{k} = {max}_{r ∈ {ℛ}_{j , i}^{h - eff} , j ≺ i} {l}_{r} ( v ) + {π}_{j}^{k} .$$

The commodity-arc prices are:

sₐ^{k}(w)=−lₐ(w)+0 if wₐ^{k}=0,

πⱼ^{k}−πᵢ^{k} if wₐ^{k}>0, where a:i→j.

Let s(w) denote the pricing scheme constructed above, and let the corresponding price potential be defined as πᵢ^{k}=max_{rε} [symbol] _{_{i,j}}_{^{h-eff}}_{,iπj}lᵣ(ν)+πⱼ^{k}. This means that s(w) is the minimum of W(w)⁺. Every positive pricing leading to commodity flow w^{k} is the sum of s(w) and of positive prices on every arc of the network, which is mathematically expressed as follows:

$${W ( w )}^{+} = s ( w ) + \{ {E}^{T} π \vert ( {E}^{T} {π}^{k} ) a \geq 0 ∀ a , k s . t . {w}_{a}^{k} > 0 \} + {vect}^{+} ( {e}_{a}^{k} , k , a s . t . {w}_{a}^{k} = 0 ) .$$

Every positive pricing will satisfy the following inequality:

$$∀ i , j ∈ E , i ≺ j ⇒ {π}_{j} - {π}_{i} \geq {max}_{r ∈ {ℛ}_{i , j}^{h - eff}} {l}_{r} ( v ) .$$

The case of equality, as for s(w), gives the minimum of the valid positive prices. The pricing scheme s(w) is the positive toll vector that realizes the minimum of the total tolls levied.

“Path tolls” is defined as the total amount of tolls charged to a user on path r (on which the flow does not vanish at equilibrium), and is the sum of the commodity arc tolls charged to that user (that is, Λₖ−lᵣ(h)).

The discussion, above, has introduced several applications of potential pricing. Network properties of the tolls levied are characterized by their formulation in the path variables.

A pricing strategy based on “potentials” will now be discussed. In the following discussion, the manner in which potential pricing allows algorithmic control the total amount of tolls and how this can be concretely achieved. In the following discussion, it is assumed that the subject traffic flow to be influenced, or controlled, is acyclic for each commodity. Let P^{k} be the total amount of tolls levied on the network for one commodity k.

Control on total tolls will be discussed in this paragraph. For a commodity flow, every total toll cost is attainable and there is a bijection between this total cost and Λₖ as follows:

P^{k}=−C^{k}(w)+dₖΛ^{k}.

Let w^{k} be such a flow. The total amount of tolls charged on users of commodity k is:

$${P}^{k} = - {\sum }_{a ∈ 𝒜} {w}_{a}^{k} {l}_{a} ( w ) + {\sum }_{a = ( i , j ) ∈ 𝒜} {w}_{a}^{k} ( {π}_{j}^{k} - {π}_{i}^{k} ) , \\ and$$

$$\begin{matrix}{\sum }_{a = ( i , j ) ∈ 𝒜} {w}_{a}^{k} ( {π}_{j}^{k} - {π}_{i}^{k} ) = {( {w}^{k} )}^{T} E π \\ = {π}^{T} {E ( {w}^{k} )}^{T} \\ = π {\overline{d}}_{k}^{T} \\ = {d}_{k} {π}_{q}^{k} - {d}_{k} {π}_{p}^{k} \\ = {Λ}_{k} {d}_{k} .\end{matrix}$$

$$Hence we have {P}^{k} = - {C}^{k} ( w ) + {d}_{k} {Λ}^{k} .$$

P^{k} is also an affine increasing function of Λ^{k} and every P^{k} can be reached by a unique Λ^{k}=(P^{k}+C^{k}(w))/dₖ.

This formula also gives us a simple expression of the total costs experienced by users:

$${C}^{tot} ( w ) = {C}^{k} ( w ) + {\sum }_{k} {P}^{k}$$

$${C}^{tot} ( w ) = {\sum }_{k} {d}_{k} {Λ}^{k} .$$

The cost of having positive prices will now be discussed. The new formulation, used in this portion of the discussion, for pricing schemes shows evidence of the difficulty of pricing with positive prices in order to achieve a social optimum type allocation. For a given commodity k, a social optimum tends to allocate a positive amount of flow to a large number of paths, even if those paths have an important travel time compared to the minimum travel time on those paths for this flow, in order to minimize total travel time. Hence, to convince selfish users to take those paths, their travel costs should not be greater than the travel costs experienced by users of the fastest path. So, in order to keep tolls positive, the fastest path should be priced as follows:

−lᵣ(h)+max_{sεPk}lₛ(h)

However, this price might be very high. One solution for this is to consider a constrained social optimum on which the amount of flow in long paths is constrained to be zero.

Pricing based on origins will be discussed in this paragraph. In order to speed up computation of pricing schemes, an efficient solution would consist of a pricing scheme depending only on the origins of the commodities (and not on the destinations.) This could be of practical interest in the situation where tolls are levied directly on each arc of the network. For example, using GPS based data would allow automatic recordation of the origins of the users, but not to anticipate their destinations. This can also avoid the difficulty of pricing a user who changes his destination during the journey. This is possible because an optimal flow going from one origin to multiple destinations is still acyclic. In the case of positive pricing, the set of prices positive on each arc is the same as in the case of only one destination.

An algorithm for price scheme design will be discussed in this paragraph. The additive nature of “potentials” allows the design of a simple technique for iterative computation of prices. Starting from the standard s(w), using the construction algorithm set forth above, it is possible to add a new potential field π′ if needed.

For example, if variable Λ^{k} is fixed for a given OD pair of the network, the new potential field should be (with k omitted in the expression of π′) such that:

π′q−π′p=Λ′k=Λk− [symbol] ^{h-eff}lᵣ(ν)

The potential field can be chosen for example as depending on the geometric distance to the origin or to the destination, or as the minimum of travel time to the node, which all define a potential field. If a distance can be defined, such as one of the previous distances mentioned, π′ᵢ=d(p,i) then multiplying the potential by Λ′ₖ/d(p,q) yields a potential field which reaches the desired Λ′ₖ. However, this might yield negative prices on roads used which emanate from the destination, which can be solved by lifting up the potentials on the successors of a given node to avoid such issues.

The results obtained in the previous section extend naturally to the case of varying demand. Let W^{ED}(w) be the set of all prices leading to the flow w in an elastic demand-user equilibrium. W^{ED}(w) is the restriction of W(w) to the shifted potential prices such that for each OD pair k, Λₖ=π_{q}^{k}−πₚ^{k}=Dₖ⁻¹(dₖ). The variational formulation for the path representation is then used:

(l(h)+ρ)^{T}(h−h*)−D⁻¹(d)^{T}(d−d*)≧0∀(h,d)εED.

If d* and d are expressed as functions respectively of h*and h, as [symbol] hᵣ=dₖ, the equation becomes:

(l(h)+ρ−D⁻¹(d))^{T}(h−h*)≧0∀h≧0.

Writing u=l(h)+ρ−D⁻¹(d), u^{T}(h−h*)≧0 where the only constraint on h is h≧0 implies uᵣ=0 for each rε [symbol] ^{h-eff}. This yields the following:

W^{ED}(h)=−l(h)+D⁻¹(d)+(eᵣ,rε [symbol] \ [symbol] ^{h-eff}).

which, then, leads to the following equation:

$${W}^{ED} ( {w}^{*} ) = - l ( {f}^{*} ) + \{ {E}^{T} π \vert {π}_{q}^{k} - {π}_{p}^{k} = {D}_{k}^{- 1} ( {d}_{k} ) ∀ k = ( p , q ) ∈ K \} + {vect}^{+} ( {e}_{a}^{k} , k , a s . t . {w}_{a}^{k} = 0 ) .$$

This result is also of practical interest for the operator. When demand is elastic, there is a direct way to control exactly the amount of flow for each OD pair, by adjusting the values Λₖ, kεK

The feature of fixed revenue will be discussed in this paragraph. The total amount of tolls is fixed in the case of elastic demand as follows:

∀kεK,P^{k}=−C^{k}(w)+dₖDₖ⁻¹(dₖ).

This is a consequence of “control on toll totals” (see related discussion above) with Λₖ=Dₖ⁻¹(dₖ).

In this portion of the discussion, the possibility of arbitrarily setting tolls on several arcs of the network will be explored. For a given set of prices on a set of arcs as follows:

{a₁, . . . ,aₙ},τₐ_{₁} . . . τₐ_{ₙ}

is there an element p in W(ν) such that for iε1 . . . n, pₐ_{ᵢ}=τₐ_{ᵢ}, or in other words, is it possible to arbitrarily set tolls on several arcs of the network. This problem can be formulated mathematically as finding p to meet the following Expression (21):

pΣW(ν) and ∀iε1 . . . n,pₐ_{ᵢ}=τₐ_{ᵢ}. (21)

This problem corresponds to the case where operators wish to make tolls vanish on certain arcs of the network, for example on residential streets and the small arterial network. A sufficient condition for the problem of Expression (21) is to have a solution that is the non-oriented subgraph [symbol] _{|τ} composed by the arcs a₁ . . . aₙ of [symbol] contain no cycle. Let p₀ be a valid pricing scheme for ν (for example p₀=s). A new pricing scheme p should satisfy the following condition:

p=p₀+E^{T}π+Σ_{i,v}_{ᵢ}₌₀λᵢeᵢ.

If δp=p−p₀, we note 6∂p=δp^{f}+δp^{c} where δp^{c} is the fixed part of δp, restriction of δp to the arcs a₁ . . . aₙ, and δp^{f} the free one. The problem can also be formulated as finding π such that:

∀iε{1 . . . n},(E^{T}π)aᵢ=δpₐ_{ᵢ}

If the rows a₁ . . . aₙ of E^{T} are linearly independent, there is a solution.

The independence of the rows of E^{T} is equivalent to the problem. If u is such that for all a≠a₁ . . . aₙ, uₐ=0 and Eu=0, then u=0. The existence of such a vector u≠0 means that there exists a circulation on the arcs a₁ . . . aₙ of [symbol] , and hence that there is a cycle in [symbol] _{|τ}. So, a sufficient condition for the existence of a valid toll vector is that [symbol] _{|τ} acyclic. A sufficient condition would be that p is a circulation (a flow respecting Kirchhoff's node rule with no exogenous flow) for every cycle of non-directed subgraph [symbol] ^{ν}∩ [symbol] _{|τ}. The maximum set of arcs for which the prices can be defined independently is the union of [symbol] \ [symbol] ^{ν} (for which they should still be greater or equal to −lₐ (fₐ)) and of the maximal spanning tree of [symbol] ν.

In the following discussion, some example computations are described as follows: (i) an explanation of methods and computational choices made in the computation code; and (ii) a description of results obtained for a network with a limited number of nodes.

A “potential pricing” algorithm will now be discussed. The computational aspects of various embodiments of the present invention may include different functionalities, such as: (i) creating an environment reproducing a road network; (ii) computing pricing schemes via convex optimization methods and verifying how close the corresponding tolled-UE is from SO; and (iii) implementing our new pricing schemes algorithms and comparing their results to the results of the existing pricing schemes.

An algorithm used to compute the minimal positive multi-commodity pricing scheme will now be described before moving along to variants of this algorithm for other applications.

The multi-commodity MINSYS algorithm will be described in this paragraph. Let w be the multi-commodity flow that we want to reach via the pricing scheme and lₐ, aε [symbol] , the travel times on the arcs of the network for flow w. For kεK, let ν=w^{k}, where ν is assumed to be acyclic. [symbol] _{ν} is the set of nodes of [symbol] _{ν} with the partial order π such that i π j if there exist a path from i to j in [symbol] _{ν}. The potential field π is defined with iteration of the following Algorithm (2) (including steps (1) to (5)):

### Step (1): Let E≠φ

Step (2): Choose i a minimal element of [symbol] _{ν}\E
Step (3): Define πᵢ=max {0, {πⱼ+lₐ|j=prec(i), a=i→j}}
Step (4): Update E=E Y {i}
Step (5): If [symbol] _{ν}\E is empty, break. Else go to Step 1.
At the end of this iteration, π is defined for every node of (see elements of proof of correctness as discussed above). Then the arc tolls for the commodity k can be expressed as follows:

sₐ^{k}(w)=−lₐ+0 if wₐ^{k}=0,

πⱼ^{k}−πᵢ^{k} if wₐ^{k}>0, where a:i→j

Variants for different objectives will be discussed in this paragraph. It is possible to use the toll vector s^{k} solution of the multi-commodity MINSYS problem to find solutions for other problems or extensions. This comes from the additivity and structure of vector space of the potential fields which gives to the set of positive prices the structure defined above. For example, the given constants Λₖ for each commodity k can be used to introduce a distance-based criterion, to take into account the elasticity of demand or to introduce a certain balance between the tolls charged to the different commodities, with:

Λk> [symbol] ^{h-eff}lᵣ(ν)

This ensures that the arc prices remain positive everywhere, multiplying the potential field of the previous paragraph by Λₖ· [symbol] ^{h-eff}lᵣ(ν) gives the desired pricing vector. Another method using additivity of potential fields, but allowing negative arc prices, is described above.

In this portion of the discussion, a comparison of the different pricing strategies is provided, based on a synthetic benchmark network. This portion of the discussion compares the different pricing schemes available and the methods used to compute them. The focus is on these different pricing problems, set forth above, and on their extensions to multi-commodity pricing. A numbered list of problem and/or objective definitions will now be set forth:

(1) MSCP This problem consists in choosing the marginal cost pricing scheme.
(2) MINSYS The objective is to minimize the total amount of tolls with nonnegative arc tolls in the network. It is computed here with convex optimization.
(3) MMINSYS The objective is to minimize the total amount of tolls with nonnegative multi-commodity arc tolls. It is computed here with the algorithm of section 4.1.
(4) MINMAX The objective is to minimize the largest nonnegative arc toll.
(5) MINTB The objective is to minimize the number of arcs for which toll is nonzero. This corresponds to two situations. First, if the toll is collected physically via booths. Second, for criteria of clarity for the user. It is computed with convex optimization program.

It is believed to be within skill in the art to achieve algorithms to compute MINMAX or MINTB problems allowing multi-commodity pricing and/or using potential pricing structure. Certain disclosures set forth above provide an idea of construction of such algorithm for MINTB, constructing a maximal spanning tree of graph [symbol] _{ν}. Nevertheless, this gives one set of arcs with tolls equal to zero per OD pair (or per origin) but not a single set of arcs with tolls equal to zero for all OD pairs.

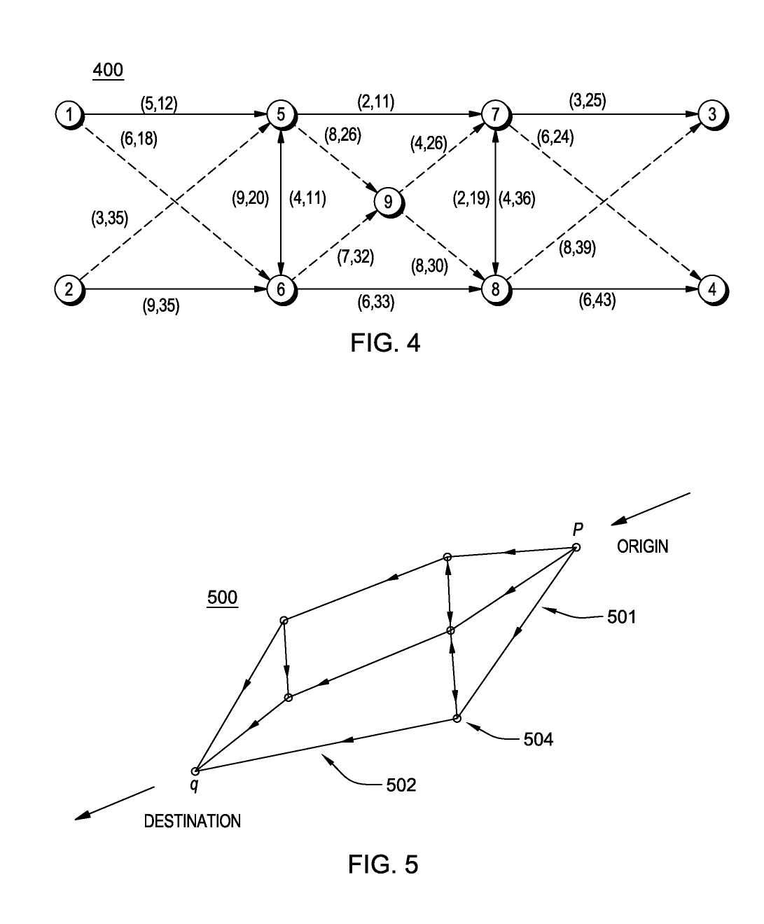

Some examples using a “nine nodes network” will now be discussed. A nine nodes network, which is a known type of network, is used as an example in the literature. As shown in FIG. 4, nine nodes network diagram 400 includes nine nodes respectively numbered 1 through 9. The arcs are given BPR (best path routing) latency functions. The tuple near an arc denotes its free flow travel time followed by its capacity in the sense of BPR.

The aggregate flow and commodity flows corresponding to the different OD pairs, at social optimum, are explicited for each arc of the network. Origin based-arc tolls, solution of the Algorithm (2), are also listed.

A comparison between SO and UE on the different arcs is described in Table (2):

| | | Arc | | | | | | | | |
|---|---|---|---|---|---|---|---|---|---|---|
| | | 0 | 1 | 2 | 3 | 4 | 5 | 6 | 7 | 8 |
| | Total cost | 9 | 10 | 11 | 12 | 13 | 14 | 15 | 16 | 17 |
| SO | 2253.92 | 9.41 | 20.59 | 38.33 | 31.67 | 0.00 | 21.30 | 26.44 | 0.00 | 39.47 |
| | | 12.78 | 29.61 | 20.76 | 0.00 | 10.39 | 39.24 | 0.00 | 29.06 | 10.16 |
| UE | 2455.84 | 8.16 | 21.847 | 7.37 | 22.63 | 0.00 | 27.84 | 27.69 | 0.00 | 44.47 |
| | | 0.00 | 38.16 | 17.37 | 0.00 | 1.84 | 42.63 | 0.00 | 27.69 | 0.00 |

The Λₖ, potential difference between the destination and the origin, are respectively 30:59, 29:21, 32:95, 31:57 for the above OD pairs. It is also an upper bound to the tolls charged to one user of the OD pair. As journeys for the different OD pairs are similar in terms of travel times, the fixed part (which does not depend on the path chosen by the user) is approximately the same for each commodity. A comparison of general properties of MMINSYS program with other optimization problems can be read in Table (3) which shows alternative tolls for the nine node network with the toll vectors being computed as explained above:

| SO total time | 2253.92 | | | | |
|---|---|---|---|---|---|
| UE total time | 2455.84 (8.95% greater) | | | | |
| Problem solution | MSCP | MINSYS | MINMAX | MINTB | MMINSYS |
| Total tolls | 1493.46 | 887.57 | 1167.57 | 887.57 | 803.6 |
| Total time/Total tolls | 66.38 | 39.38 | 51.80 | 66.38 | 35.65 |
| Number of toll booths | 14 | 5 | 7 | 5 | 6 |
| Max. arc toll | 16.88 | 11.20 | 8.00 | 11.20 | 12.00 |

Some comparisons between the new formulation MMINSYS and other classical programs are as follows: (i) MMINSYS solution gives a lower total of tolls than MINSYS (this is mathematically evident, as MINSYS is a problem restriction of MMINSYS; MMINSYS total tolls are 9.5% lower); and (ii) MMINSYS solution also gives interesting values for the number of tolled arcs or for the maximum arc toll. More specifically with respect to item (ii), there are 5 arcs tolled for each commodity, which represents 6 arcs together. The maximum arc toll is 8:00 for one commodity, 12:00 for the other, which is a little bit more than MINSYS solution and MINTB solution (identical in this problem).

The notion of commodity-based potential pricing in order to design optimal OD-pair differentiated congestion prices, in the context of real-time GPS sensing, has now been introduced. This introduction includes the mathematical construction and analysis of commodity-based potential prices pricing, the design of algorithmic methods for efficient computation of these potentials, and the theoretical and numerical analysis of their properties. It has been shown that a potential-based formulation provides a new characterization of the set of pricing schemes such that the charge incurred on each arc is positive, whose existence is equivalent to the acyclic property of the commodity flows. This proof of this equivalence result is constructive, and is based on a linear algorithm for the definition of a minimal positive pricing scheme.

In the framework set forth above, different pricing strategies are proposed and analyzed, taking into account operator and user preferences. For example, we describe how to introduce distance-based charges in the arc prices. The case of elastic demand is also considered and characterized as a fixed potential difference between the destination and the origin potential. An algorithm to construct a positive commodity-based potential pricing scheme leading to a social optimum flow with the secondary objective of minimizing total tolls has also been provided above. Numerical results on a benchmark network of interest allow the assessment of the computational and practical performances of the pricing scheme introduced herein.

Some embodiments of the present invention may include one, or more, of the following features, characteristics and/or advantages: (i) design a differentiated pricing scheme representing a desired traffic level given current demand and network performance functions using a network model; (ii) design a differentiated pricing scheme that computes the set of differentiated prices which induce the demand to a desired traffic level; (iii) achieve a specific objective given operational constraints; (iv) allow prices to differ across users by their origin and destination; (v) allow prices to differ by a user's location, time of day/day of week, and/or traffic level; (vi) allow prices to differ by emissions; (vii) allow prices to differ by noise level; (viii) allow prices to differ by fuel consumption; (ix) allow prices to differ by driving style (x) allow prices to differ by vehicle acceleration; (xi) allow prices to differ by circuitous driving prior to parking; (xii) allow prices to differ by obtaining and using trajectory information from a geo-positioning device; (xiii) allow prices to differ by obtaining and using information from a fixed re-identification detector(s); (xiv) minimize the total amount of tolls charged; (xv) minimize the maximum toll charged to a user; (xvi) minimize the maximum toll charged to a user at a specific location; (xvii) minimize price heterogeneity between users; (xviii) minimize the discrepancy between desired total toll amount and total toll amount charged; (xix) take into account the GPS coverage level of service by substituting the total driving time for the route of the vehicle to ensure robustness to GPS errors; (xx) take into account the GPS coverage level of service by setting prices such that similar routes have either the same price or significantly different travel times to ensure robustness to GPS errors; and/or (xxi) have operational constraints that include incentives (negative tolls), fixed charges for a sub-network, and/or fairness.

Some embodiments of the present invention use the following as inputs: (i) a road network as a graph [symbol] =( [symbol] , [symbol] ), where are the [symbol] is the set of nodes (intersections) and [symbol] is the set of directed arcs (segments); (ii) origin-destination (OD) flows (dₖ)_{kεK} demand (in units such as vehicles per hour, or vph) per OD pair k=(p,q)εK, where K is the set of OD pairs; and (iii) latency functions fₐ→lₐ(fₐ) which represent travel time (for example, minutes) on arc a for a given value of flow fₐ.

FIG. 5 shows a roadmap (or “map” or “graph”) 500 including a number of nodes that are interconnected by road segments (also called “directed arcs”). Map 500 includes: node 504; origin node p; destination node q; and directed arcs 501, 502. As can be seen from graph 500, there are a number of different routes from p to q following the directed arcs. One such path is along arc 501, through node 504, and thence along arc 502.

Some embodiments of the present invention represent fₐ, the state variable for the traffic flow on each arc a, in one or more of the following forms and/or units: (i) vph; (i) a path representation, h=(hᵣ)_{rε} [symbol] , where [symbol] is the set of acyclic paths and h is a path flow vector over [symbol] ; (ii) a commodity-arc representation, w=(w^{k})_{kεK}=(wₐ^{k})_{kεK,aεA}, where w is an arc flow vector over K and A, and one commodity is equivalent to one OD pair; and/or (iii) with generic notation, νεV, where ν is a feasible flow vector.

Some embodiments of the present invention assume one or more of the following: (i) time-money equivalence, wherein x minutes of travel has the same cost to a user as y*x dollars, where y is the monetary value of time; (ii) selfish behavior, where all drivers behave in the same way and want to minimize their travel costs; and/or (iii) a static model, where traffic is at equilibrium and traffic data is constant over time.

Some embodiments of the present invention recognize a difference between a socially optimum traffic allocation, defined as the best allocation on roads for all users in the aggregate, and a user equilibrium traffic allocation, which is the natural state of traffic when users behave in a selfish way such that there is no path change from a source p to a destination q that will lower travel costs for a given user navigating from p to q.

In some embodiments of the present invention, the socially optimum allocation of flows f* on paths is defined as:

$${min}_{f ∈ F} C ( f )$$

$$where$$

$$C ( f ) = {\sum }_{a ∈ 𝒜} {f}_{a} {l}_{a} ( {f}_{a} )$$

which is the allocation that minimizes the total (aggregate) travel time (that is, global cost, or C(f)) for all users. This can also be expressed in standard form as:

$${min}_{v ∈ V} C ( v )$$

or in terms of a variational inequality problem (VIP) as:

∀νεV,∇C(ν*)^{T}(ν−ν*)≧0

In some embodiments of the present invention, the user equilibrium allocation of flows is defined as:

$${min}_{f ∈ F} {\sum }_{a} {\int }_{0}^{{f}_{a}} {l}_{a} ( x ) d x$$

or in terms of a variational inequality problem (VIP):

∀νεV,l(ν*)^{T}(ν−ν*)≧0

Some embodiments of the present invention recognize: (i) the selfish behavior of users, who wish to minimize their travel costs; (ii) that travel costs may consist of both travel time and tolls; (iii) that tolls in a network can therefore be used to modify the user equilibrium which is reducible to a mathematical expression as will be understood by those of skill in the art; and (iv) that the pricing problem then becomes one of generating a set of valid prices which is likewise reducible to a mathematical expression as will be understood by those of skill in the art.

One conventional approach to this problem is via marginal cost. Namely, increasing the flow by a small quantity Δf on a path r adds a marginal cost ΔC to the total cost, where ΔC includes both an additional total travel time due to the flow increase (that is, the travel time of the added traffic itself) plus an additional travel time, on average, for all of the drivers in the network because of this added traffic. This latter component of ΔC can be considered an externality, and the marginal cost approach seeks to internalize these externalities by charging every driver the cost he incurs to others. Such an approach can lead to an optimal solution in the sense that the user equilibrium will correspond to the social optimum that minimizes the total travel time for all users on the network as a whole.

Some embodiments of the present invention recognize that it is possible to achieve the social optimum through lower tolls than those produced using the marginal cost approach. In particular, it is possible to find an optimal solution to the following convex optimization problem: find f*ₐ flows on arcs and ρ*ₐ tolls on arcs (ρ*ₐ is a price given on arc a) such that:

(i) f*ₐ minimizes the total travel time C(f) (that is, f* is a solution of min C(f) over all fεF);
(ii) f*ₐ is a user equilibrium for the tolled network, for which the travel cost is the sum of the * i travel time and tolls on the paths, meaning:

∀fεF,(l(f*)+ρ)^{T}(f−f*)≧0

and (iii) ρ*ₐ respects some specific constraints, such as fairness or other user-driven or operator-driven constraints (that is, ρ* is a solution of min [symbol] (ρ) over all ρ>0, where is the set of all routes). This problem will be herein referred to as the Toll Optimization Problem.

Some embodiments of the present invention solve the Toll Optimization Problem using a potential pricing approach that includes one, or more, of the following features, characteristics, and/or advantages: (i) the assumption that latency functions are strictly increasing; (ii) the assumption that cost functions are strictly convex; (iii) ρₐ, the price for each arc, is assigned the value −lₐ(f*ₐ) in order to reach the optimal solution; and/or (iv) terms orthogonal to the variations of the flow are added to the term in (iii).

Some embodiments of the present invention model the potential pricing approach as:

W(w*)=−l(f*)+Im(E^{T})+vect⁺(eₐ^{k},k,as·t·wₐ^{k}=0)

where w* is the commodity flow at which a tolled user equilibrium is desired and E is the node-arc incidence matrix In a subset of these embodiments, the price charged to commodity k on arc a with upstream node i and downstream node j is computed as:

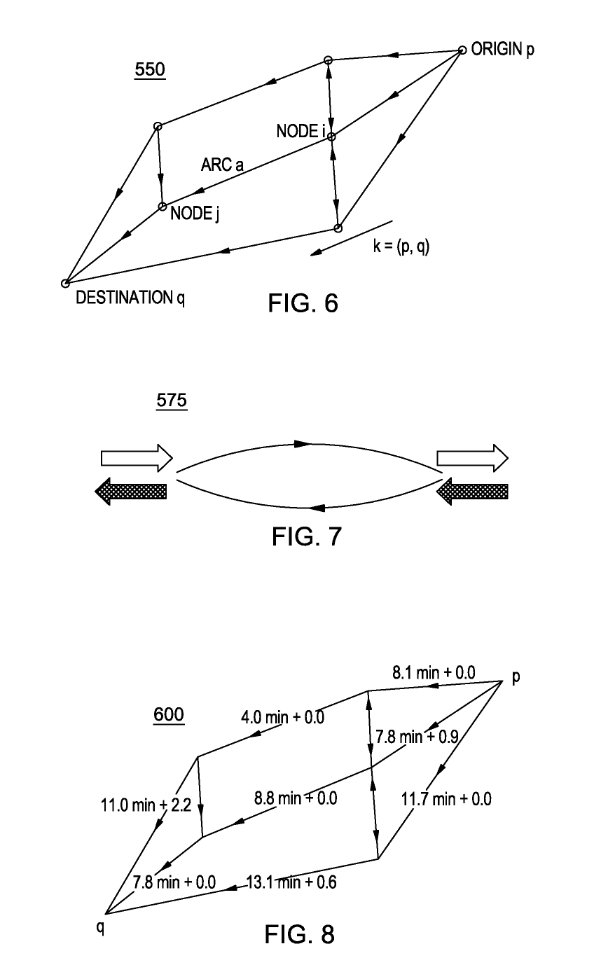

ρₐ^{k}=−lₐ(fₐ*)+πⱼ^{k}−πᵢ^{k}+(μₐ^{k}≧0 if wₐ^{k}=0)

where=−lₐ(f*ₐ) “compensates” the travel time experienced by the user, πⱼ^{k}−πᵢ^{k} is the potential difference between nodes i and j, and μₐ^{k} is a positive constant on non-used arcs, which can be interpreted as a “penalty” for using non-expected paths. FIG. 6, showing map (or “graph” 550 with origin p, destination q, origin-destination pair k=(p,q), nodes i and j, and arc a, illustrates an instance in which this formulation can be applied.

The general solution to the Toll Optimization Problem presented above has the following characteristics: (i) ρₐ=−lₐ(f*ₐ) is a solution; (ii) on an acyclic sub-graph where w* is non-zero, the problem is equivalent to:

ρ+l(f*)ε{w|Ew=0}^{⊥}=Im(E^{T})

and its solutions are the differences of potential fields:

(E^{T}π)ₐ=(πⱼ−πᵢ),a=(i,j)

and (iii) on the arcs where flow vanishes, there is an extra degree of freedom, so prices can be higher.

Some embodiments of the present invention constrain pricing solutions of the potential pricing model to those solutions where all tolls are greater than or equal to zero. Some of these positive-pricing embodiments recognize: (i) there exists a potential pricing in W(ν) that is positive everywhere if and only if ν is acyclic; (ii) if w is optimal, then for each k, w^{k} is acyclic; and/or (iii) aggregate flow need not be, and generally is not, acyclic (for example, where there are symmetric origin-destination pairs, as illustrated by diagram 575 in FIG. 7).

In some positive-pricing embodiments, a pricing scheme is constructed as follows:

$${π}_{i}^{k} = {max}_{r ∈ {ℛ}_{j , i}^{h - eff} , j ≺ i} {l}_{r} ( v ) + {π}_{j}^{k}$$

$${s}_{a}^{k} ( w ) = - {l}_{a} ( w ) + \{ \begin{matrix}0 & if {w}_{a}^{k} = 0 , \\ {π}_{j}^{k} - {π}^{ki} & if {w}_{a}^{k} > 0 , where a : i -> j\end{matrix}$$

where πᵢ^{k} is the price potential of node i for origin-destination pair k and sₐ^{k}(w) are the commodity-arc prices. If W(w)⁺ is defined as the desired set of equilibrium commodity flows in which all toll prices are positive, then s(w) is the minimum of W(w)⁺, and

W(w)⁺=s(w)+{E^{T}π|(E^{T}π^{k})ₐ≧0∀a,ks·t·wₐ^{k}>0}+vect⁺(eₐ^{k},k,as·t·wₐ^{k}=0)

That is, every positive pricing leading to commodity flow w^{k} is the sum of s(w) and of positive prices on every arc in the network, and s(w) is the positive toll vector solution that achieves the minimum total tolls levied. In path representation, the sum along a path between origin-destination pair k=(i, j) of the commodity arc potential pricing is denoted Λₖ=πⱼ^{j}−πᵢ^{k}, and Λₖ≧max lᵣ(h) over rε [symbol] ₖ^{h-eff}.

Given a graph [symbol] of which [symbol] _{ν} is a directed subgraph, a partial order i π j if there exists a path from i to j in [symbol] _{ν}, and [symbol] _{ν}=( [symbol] _{|} [symbol] _{ν}, π) as a partially ordered set of nodes in [symbol] _{ν}, some embodiments of the present invention use the following Algorithm (3) (including Steps (0) to (4)) to compute s(w):

### Step (0) Let E=Ø;

Step (1) Choose i a minimal element of [symbol] _{ν}\E;
Step (2) Define πᵢ=max 0, {πⱼ+lₐ(νₐ)|j=prec(i), a=i→j}
Step (3) Update E=E Y {i}.
Step (4) If [symbol] _{ν}\E is empty, then break, otherwise go to Step (1).

Shown in FIG. 8 is graph 600, illustrating the tolls (in latency-equivalent terms) calculated as the result of this algorithm for the origin-destination pair (p, q) (note: values are not shown for all arcs).

Some embodiments of the present invention utilize a potential pricing approach and achieve one, or more, of the following benefits: (i) control of the amount of tolls:

P^{k}=−C^{k}(h)+dₖ(π_{q}^{k}−πₚ^{k})

(ii) support for elastic demand:

$${π}_{q}^{k} - {π}_{p}^{k} = {D}_{k}^{- 1} ( {d}_{k} ) + {max}_{r} {l}_{r} ( {f}^{*} )$$

(iii) ability to use pre-defined prices on some arcs (if the arcs where prices are pre-defined do not form a non-directed cycle, then there exists a commodity pricing with these prices at these arcs; if there is a non-directed cycle, then there is a solution if and only if pre-defined prices define a “circulation” on this cycle); and/or (iv) ability to take into account GPS errors given a first path directly from i to j and a second path from i to j via m, the cost on the first path is πⱼ^{k}−πᵢ^{k}−l_{first}(f*), while the cost along the second path is πⱼ^{k}−πᵢ^{k}−l_{second}(f*)).

Some embodiments of the present invention use the commodity arc pricing scheme and have one, or more, of the following features, characteristics, and/or advantages: (i) provide a clean analytical expression of tolls leading to a social optimum of the multi-commodity pricing problem; (ii) ensure linear computation; (iii) reach any acyclic flow; (iv) provide more solutions than alternative methods; (v) produce lower tolls than alternative methods; (vi) are faster/shorter than alternative methods; (vii) permit direct control of toll amount and/or some user constraints; (viii) permit an analytical expression of the result; and/or (ix) use only positive tolls on each arc.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above similar cautions apply to the term “embodiment.”

and/or: inclusive or; for example, A, B “and/or” C means that at least one of A or B or C is true and applicable.

Software storage device: any device (or set of devices) capable of storing computer code in a manner less transient than a signal in transit.

Tangible medium software storage device: any software storage device (see Definition, above) that stores the computer code in and/or on a tangible medium.

Non-transitory software storage device: any software storage device (see Definition, above) that stores the computer code in a non-transitory manner.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

Tolls: includes positive, negative and zero tolls; includes, but is not necessarily limited to tolls that can be easily measured in cash, or money, terms; in the case of a positive toll, “charging a toll” could mean paying the user of a vehicle money instead of receiving money from the user of the vehicle.

1. A method comprising:
collecting demand information representing estimated usage of a plurality of roads by a plurality of vehicles, with each road including at least one road portion; and
determining a plurality of sets of tolls with each set of tolls: (i) respectively corresponding to a specific respective vehicle of the plurality of vehicles, (ii) including tolls for each road portion of the plurality of roads, and (iii) being based, at least in part, upon the estimated usage;
wherein:
at least the determination of a plurality of sets of tolls is performed by a machine using machine logic.

2. The method of claim 1 wherein the determination of the plurality of sets of tolls further determines the sets of tolls so that each set of tolls corresponds respectively to a specific planned journey from an origin location to a destination location by a specific vehicle.

3. The method of claim 1 further comprising:
determining a desired traffic flow pattern by the plurality of vehicles over the road portions;
wherein:
the determination of the plurality of sets of tolls is made to incentivize the plurality of vehicles to follow an actual traffic flow pattern that is closer to the desired traffic flow pattern than a natural traffic flow pattern; and
the natural traffic flow pattern is a traffic flow pattern which the vehicles would follow absent any tolls.

4. The method of claim 3 wherein determination of the desired traffic pattern includes:
estimating vehicle demand; and
applying a first network performance function using a network model.

5. The method of claim 3 wherein the determination of the plurality of sets of tolls is made based, at least in part, on consideration of at least one of the following additional objectives: (i) decreasing a total amount of tolls charged collectively to the plurality of vehicles, (ii) decreasing a maximum toll charged to a vehicle, (iii) decreasing a maximum toll charged to a vehicle at a specific location, (iv) decreasing price heterogeneity between vehicles, and/or (v) decreasing a discrepancy between a predetermined desired total toll amount and a total toll amount.

6. The method of claim 1 wherein the tolls of each set of tolls is based, at least in part, on the identity of the vehicle to which the set of tolls applies and at least one of the following additional factors: (i) the vehicle's origin location, (ii) the vehicle's destination location, (iii) a time of day; (iv) a day of week, and/or (v) a desired traffic level.

7. The method of claim 1 wherein the determination of the plurality of sets of tolls is determined under at least a first operational constraint.

8. The method of claim 7 wherein the first operational constraint is one of the following: (i) a predetermined, fixed toll for at least one road portion, or (ii) a fairness constraint.

9. The method of claim 1 wherein the determination of the plurality of sets of tolls is based, in part, on at least one of the following factors: (i) emissions of the vehicle corresponding to a set of tolls, (ii) noise level of the vehicle corresponding to a set of tolls, and/or (iii) fuel consumption of the vehicle corresponding to a set of tolls.

10. The method of claim 1 wherein the determination of the plurality of sets of tolls is based, in part, on at least one of the following factors: (i) a driving style of the vehicle corresponding to a set of tolls, and (ii) circuitous driving prior to parking of the vehicle corresponding to a set of tolls.

11. The method of claim 1 wherein the determination of the plurality of sets of tolls is based, at least in part, on trajectory information respectively associated with the vehicles of the plurality of vehicles.

12. The method of claim 11 further comprising:
determining trajectory information for at least some of the vehicles of the plurality of vehicles using at least one of the following: (i) data from geo-positioning devices, and/or (ii) data from fixed re-identification detectors.

13. The method of claim 1 further comprising:
determination of routes taken by each vehicle of the plurality of vehicles over the road portions of the plurality of road portions; and
charging tolls to the vehicles based upon the sets of tolls.

14. The method of claim 13 wherein the determination of routes is based upon at least one of the following factors: (i) data received from global positioning devices in or on the vehicles of the plurality of vehicles, and/or (ii) a driving time for a vehicle

15. The method of claim 13 wherein the determination of the plurality of sets of tolls ensure that geographically proximate routes that have similar expected associated travel times will have at least approximately the same toll.

16. A computer program product comprising software stored on a software storage device, the software comprising:
first program instructions programmed to collect demand information representing estimated usage of a plurality of roads by a plurality of vehicles, with each road including at least one road portion; and
second program instructions programmed to determine a plurality of sets of tolls with each set of tolls: (i) respectively corresponding to a specific respective vehicle of the plurality of vehicles, (ii) including tolls for each road portion of the plurality of roads, and (iii) being based, at least in part, upon the estimated usage;
wherein:
the software is stored on a software storage device in a manner less transitory than a signal in transit.

17. The product of claim 16 wherein the second program instructions are further programmed to determine the sets of tolls so that each set of tolls corresponds respectively to a specific planned journey from an origin location to a destination location by a specific vehicle.

18. The product of claim 16 wherein the software further comprises:
third program instructions programmed to determine a desired traffic flow pattern by the plurality of vehicles over the road portions;
wherein:
the second program instructions are further programmed to determine the plurality of sets of tolls to incentivize the plurality of vehicles to follow an actual traffic flow pattern that is closer to the desired traffic flow pattern than a natural traffic flow pattern; and
the natural traffic flow pattern is a traffic flow pattern which the vehicles would follow absent any tolls.

19. A computer system comprising:
a processor(s) set; and
a software storage device;
wherein:
the processor set is structured, located, connected and/or programmed to run software stored on the software storage device; and
the software comprises:
first program instructions programmed to collect demand information representing estimated usage of a plurality of roads by a plurality of vehicles, with each road including at least one road portion; and
second program instructions programmed to determine a plurality of sets of tolls with each set of tolls: (i) respectively corresponding to a specific respective vehicle of the plurality of vehicles, (ii) including tolls for each road portion of the plurality of roads, and (iii) being based, at least in part, upon the estimated usage.

20. The system of claim 19 wherein second program instructions are further programmed to determine the sets of tolls so that each set of tolls corresponds respectively to a specific planned journey from an origin location to a destination location by a specific vehicle.
